(19) United States
(12) Patent Application Publication
(10) Pub. No.: US 2026/0368039 A1
(43) Pub. Date: Nov. 19, 2026

(54) Continuous Backup with Point in Time Restore

(71) Applicant: Couchbase, Inc., San Jose, CA (US)

(72) Inventors: Matthew James Hall, Manchester (GB); Benjamin Thomas Huddleston, Stockport (GB); James William Walker, Littleborough (GB); Sarath Lakshman, Santa Clara, CA (US)

(21) Appl. No.: 19/210,688

(22) Filed: May 16, 2025

(51) Int. Cl. G06F 11/1446; G06F 11/1471; G06F 11/1474; G06F 16/27

(52) U.S. Cl. CPC G06F 11/1448; G06F 11/1471; G06F 11/1474; G06F 16/275

(57) ABSTRACT

A method for continuous backup in a distributed database system with multiple nodes. The method includes receiving and synchronizing database transactions between an active and a replica database node, each transaction assigned a sequence number. The active database node periodically generates transaction logs, backing up consecutively executed transactions with corresponding timestamps. In response to detecting a failover event, a replica database node is promoted to a new active database node, which executes a new transaction with a sequence number subsequent to the last successfully synchronized transaction. The new active database node generates a failover log and identifies a gap between the latest backed-up transaction and the last successfully synchronized transaction. The new active database node also generates a new transaction log covering the missing transactions.

### BACKGROUND

### Field of Art

This disclosure relates in general to distributed databases, and in particular to continuous backup with point in time restore in distributed databases.

### Description of the Related Art

Various database systems, including relational (e.g., SQL) and NoSQL databases, are configured to handle large volumes of structured, semi-structured, and unstructured data. NoSQL databases are particularly optimized for scalability, flexibility, and high performance, making them well-suited for big data and real-time applications. A typical NoSQL system may employ key-value storage, in which each piece of data is associated with a unique key and stored in an append-only manner that preserves the order of updates. Many modern databases use log-structured storage approaches, which write new data as immutable records while retaining historical versions, rather than overwriting values in-place. This write-optimized approach is efficient for high-throughput workloads, though it may increase storage overhead.

Traditional backup strategies rely on periodic snapshots—taken at intervals such as hourly or daily—to capture the state of the database. However, any data changes occurring between snapshots can be lost, especially if a failure occurs. This risk is unacceptable in industries like finance, where losing even a few minutes of data could result in significant impact. There is thus a need for systems that can restore data to a precise moment in time, minimizing recovery point objectives and ensuring high reliability under failure conditions.

### SUMMARY

This disclosure relates to a method for continuous backup in a distributed database system including multiple database nodes, such that granularized restoration at any given time point is enabled.

In some embodiments, the database system receives and executes a sequence of database transactions at an active database node, each assigned a sequence number. In some embodiments, a transaction refers to a set of operations that are executed with ACID (Atomicity, Consistency, Isolation, Durability) guarantees. These ACID transactions may include multiple reads and writes across documents and collections and are treated as a single, atomic unit of work that either fully succeeds or fails. ACID transactions are particularly important in applications that require strong consistency even in distributed environments. In some embodiments, ACID transactions may be opt-in and explicitly invoked, rather than being applied automatically to all operations.

Transactions are synchronized to a replica database node, which periodically generates and stores transaction logs that capture sequence numbers and timestamps of executed transactions. When a failover event occurs, the system reclassifies the replica database node as the active database node (without physically moving or copying data), and the newly active node begins processing transactions with sequence numbers subsequent to the last successfully synchronized transaction. The new active database node records the failover event and identifies a gap between the latest backed-up transaction and the last successfully synchronized transaction. To preserve data integrity, the new active database node generates a new transaction log to cover this gap, thereby ensuring a consistent and complete transaction history. In some embodiments, while the transaction logs are initially generated by the transaction module during normal operation, they are subsequently copied to a designated backup location by the continuous backup module.

In some embodiments, the system also periodically generates backup snapshots at a predefined frequency. The backup snapshots provide a baseline for data restoration, while the transaction logs maintain fine-grained transaction history at a higher frequency. When a restoration request specifying a time point is received, the system identifies backup snapshots taken before the specified time points, retrieves transaction logs recorded after the latest identified backup snapshot, and extracts transactions executed between the latest backup snapshot and the target time point. The system can restore the database to a baseline version using the identified backup snapshots, and replays the extracted transactions on the baseline version of the database to reconstruct the database state at the specified time.

In some embodiments, the restoration process also considers failover events, ensuring transactions are correctly applied from both the previously active and new active database nodes. In some embodiments, the system identifies pre-failover transaction logs from the previously active database node, and identifies post-failover transaction logs from the new active database node. The system extracts transactions leading up to and following the failover event from the identified pre-failover transaction logs and post-failover transaction logs to maintain data continuity.

As such, the embodiments described herein enhance database reliability, failover resilience, and restoration precision in distributed database environments. By combining periodic snapshots, transaction logs, and failover logs, the system provides granular recovery, minimal data loss, and efficient failover handling, ensuring the database can be restored to any exact point in time.

### BRIEF DESCRIPTION OF THE DRAWINGS

FIG. 1 is a block diagram of a distributed database system environment for performing transactions in accordance with one or more embodiments.

FIG. 2 is a block diagram of an embodiment of a database server in accordance with one or more embodiments.

FIGS. 3A-3P are sequence diagrams illustrating embodiments of continuous backup in the distributed database system, in accordance with one or more embodiments.

FIG. 4A-4O are sequence diagrams illustrating embodiments of restoration at a specific timestamp in the distributed database system, in accordance with one or more embodiments.

FIG. 5 illustrates an example environment including multiple database nodes, in accordance with one or more embodiments.

FIG. 6 is a flow chart illustrating an example method for continuous backup in a distributed database system in accordance with one or more embodiments.

FIG. 7 is a flowchart illustrating an example method for restoring a database system to a specific time point in accordance with one or more embodiments.

FIG. 8 is a high-level block diagram illustrating a functional view of a typical computer system for use as one of the entities illustrated in FIG. 1, according to an embodiment.

### DETAILED DESCRIPTION

A NoSQL (Not Only SQL) database system is capable of handling large volumes of unstructured, semi-structured, and structured data without relying on the relational database model. Examples of NoSQL databases include (but are not limited to) key-value stores (where data is stored as key-value pairs), document stores (where data is stored as semi-structured documents in formats like JSON (JavaScript Object Notation), BSON (Binary JSON), or XML (Extensible Markup Language)), graph databases (where data is represented as nodes (entities) and edges (relationships)), time-series databases, object oriented databases among others.

NoSQL databases are optimized for scalability, flexibility, and high performance, and are well-suited for big data and real-time applications. Many NoSQL systems use key-value storage, where data is stored as a unique key and its associated value. In such systems, writes are often implemented in an append-only manner, meaning that updates do not overwrite existing data but instead create new versions while preserving prior ones. This model supports efficient write throughput and simplifies crash recovery, though it may increase storage usage due to the accumulation of historical versions. Traditional backups-typically performed at coarse intervals such as hourly or daily-introduce risk of data loss between backup points. For industries such as banking or financial services, where data consistency and minimal data loss are paramount, the traditional model is inadequate. These environments demand the ability to recover data to precise moments in time, sometimes down to the granularity of seconds or less.

Unlike traditional backup systems that rely on periodic snapshots, which may result in data loss between backups, the embodiments described herein address these issues by combining snapshot backups with transaction log backups. This approach enables point-in-time recovery with fine-grained data retention, effectively minimizing the recovery point objective (RPO).

In some embodiments, the database system may be an append-only storage system, configured to operate by continuously data files associated with sequence numbers (seqnos) that track changes in the database. In some embodiments, these files may include complete records of document mutations (e.g., inserts, updates, deletes) associated with each sequence number. Alternatively, these files may merely include index entries. The database system ensures data consistency even when failovers occur, meaning if an active database node crashes, a replica database node can take over and continue backup operations with minimum data loss. In some embodiments, the database system employs gap filling, which detects missing data sequences and reconstructs them from replica database nodes.

During restoration, the database system reconstructs the database state by first restoring a traditional backup and then replaying logged changes to reach an exact point in time. This approach balances performance, storage efficiency, and resilience against node failures. As such, the embodiments described herein enhance data durability, high availability, and minimal data loss, making it ideal for real-time applications and mission-critical enterprise environments, such as financial transactions.

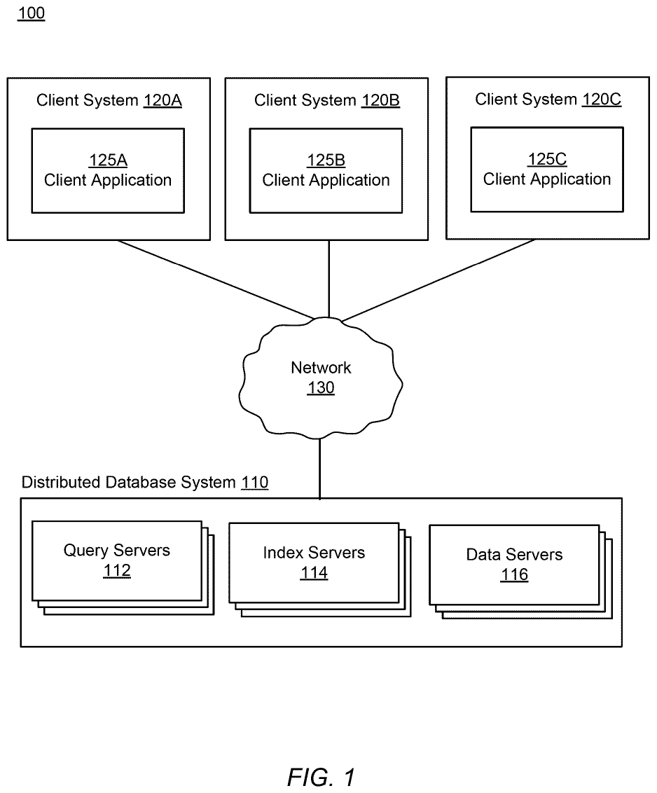

Additional details about the database system are further described below with respect to FIGS. 1-7.

### System Environment

FIG. 1 is an embodiment of a block diagram of system environment 100 for distributed processing of transactions for a distributed database system. In the embodiment shown, the system environment 100 includes a distributed database system 110, client systems 120, and a network 130. Other embodiments may use more, fewer, or different systems than those illustrated in FIG. 1. Functions of various modules and systems described herein can further be implemented by other modules or systems than those described herein.

The distributed database system 110 manages a distributed database. The distributed database system 110 includes a set of distributed database nodes including distributed query servers 112, distributed index servers 114, and distributed data servers 116. The distributed database nodes may be individual servers or server clusters, virtual database nodes distributed to one or more physical servers, or some combination thereof. The distributed database system 110 enables the client systems 120 to execute transactions on data stored in the data servers 116 via communication with one or more components of the distributed database system 110.

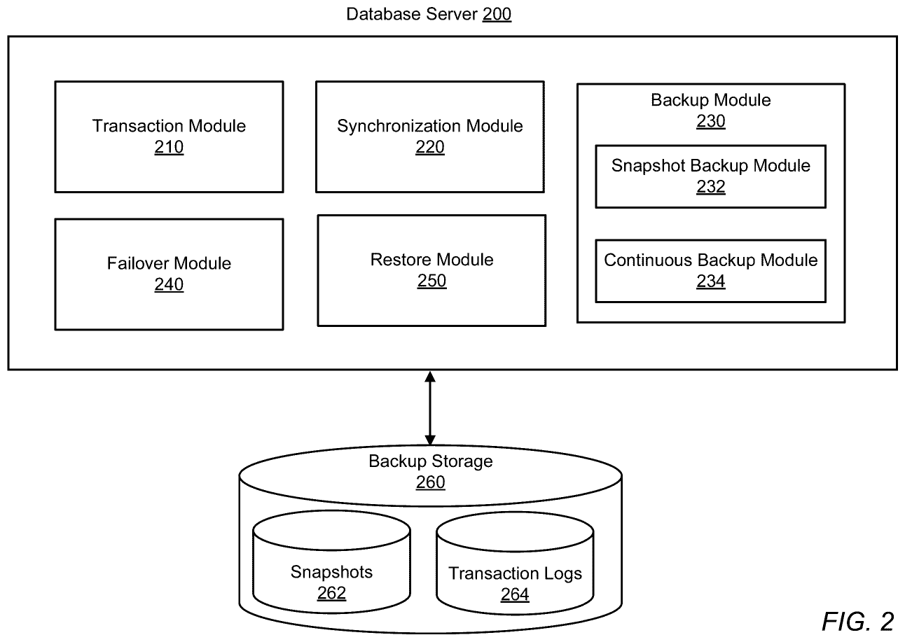

In an exemplary embodiment, the client systems 120 execute transactions by communicating directly with the data servers 116, as described in greater detail below with reference to the client systems 120 and FIG. 2. Although FIG. 1 shows a single element, the distributed database system 110 broadly represents a distributed database including the distributed query servers 112, the index servers 114, and the data servers 116 which may be located in one or more physical locations. The individual elements of the distributed database system 110 may be any computing device, including but not limited to: servers, racks, workstations, personal computers, general purpose computers, laptops, Internet appliances, wireless devices, wired devices, multi-processor systems, mini-computers, cloud computing systems, and the like. Furthermore, the elements of the distributed database system 110 depicted in FIG. 1 may also represent one or more virtual computing instances (e.g., virtual database nodes), which may execute using one or more computers in a datacenter such as a virtual server farm. As such, the query servers 112, index servers 114, and data servers 116 may each represent one or more database nodes, such as one or more virtual database nodes, executed on one or more computing devices.

The query servers 112 facilitate queries on the distributed database. In particular, the query servers 112 may process query statements received from the client systems 120 represented using one or more query languages (e.g., structured query language (SQL), GraphQL, non-first normal form query language (N1QL or SQL++), etc.). The query servers 112 may generate query execution plans (QEPs) using received query statements. QEPs may be generated using various techniques, such as those described in co-pending U.S. patent application Ser. No. 16/785,499, filed Feb. 7, 2020, which is incorporated herein by reference in its entirety. In some embodiments, the query servers 112 facilitate execution of transactions including one or more statements represented using a declarative query language, such as by using any of the methods described in co-pending U.S. patent application Ser. No. 17/007,561, filed Aug. 31, 2020, which is incorporated herein by reference in its entirety.

The index servers 114 manage indexes for data stored in the distributed database system 110. In various embodiments, the index servers 114 can receive requests for indexes (e.g., during execution of a transaction) from the query servers 112, directly from the client system 120, or some other element of the system environment 100. The index servers 114 can generate indexes for one or more fields of records stored by the data servers 116. Indexes stored by the index servers can include B-tree indexes, inverted tree indexes, hash indexes, R-tree indexes, GIST indexes, or any other suitable type of database index. The index servers 114 may automatically generate or update indexes for one or more records stored in the data server 116 based on transactions performed by the distributed database system 110. Additionally, or alternatively, the index servers 114 may automatically generate or update indexes for one or more records stored in the data server 116 based on a request (e.g., an instruction associated transaction) received from another component of the distributed database system 110 (e.g., the query servers 112). In some embodiments, a given index server of the index servers 114 manages indexes stored on a corresponding index storage server or server cluster. In the same or different embodiments, a given index server of the data servers 116 manages indexes stored locally on the given data server. As described above with reference to the distributed database system 110, an index server 114 may be a virtual database node executed on one or more computing devices (e.g., a server computer or server cluster), where each of the one or more computing devices can include one or more virtual database nodes.

The data servers 116 manage data organized into records in a distributed database of the distributed database system 110. In various embodiments, the data servers 116 can provide requested data to other elements of the system environment 100 (e.g., the query servers 112) and store new or modified data in the distributed database. In particular, the data servers 116 can commit new or modified data to the distributed database in response to receiving instructions to execute corresponding transactions directly from the client systems 120 and/or other components of the distributed database system 110 (e.g., query servers 112). In some embodiments, in processing instructions to execute transactions, the data servers 116 maintain the ACID properties of transactions (atomicity, consistency, isolation, and durability). The distributed database may be one of various types of distributed databases, such as a document-oriented database, a key-value store, a graph database, a relational database, a wide-column database, or a search index. Similarly, records storing data in the distributed database of the distributed database system 110 may be represented using various formats or schemas based on the type of database used, such as relational tables or documents (e.g., JavaScript Object Notation (JSON) or XML documents). In some embodiments, a given data server of the data servers 116 manages data stored on a corresponding data storage server or server cluster. In the same or different embodiments, given data server of the data servers 116 manages data stored locally on the given data server. As described above with reference to the distributed database system 110, a data server 116 may be a virtual database node executed on one or more computing devices (e.g., a server computer or server cluster), where each of the one or more computing devices can include one or more virtual database nodes.

The data servers 116 may include multiple copies of data (e.g., redundant backup copies) distributed across multiple data servers 116. In this case, copies of data on an active data server 116 (also referred to as an active database node) may be used for client read and write operations on the data with redundant copies of the data on one or more other data servers 116 (also referred to as replica database nodes). After modifications are made to data stored on the active data server 116 (e.g., mutations or insertions), the distributed database system 110 propagates the modifications to the redundant copies on the one or more other data servers.

The client systems 120 (e.g., the client systems 120A, 120B, or 120C) are client computing systems that communicate with the distributed database system 110 to execute transactions. The client system 120 may include one or more computing devices, such as personal computers (PCs), mobile phones, server computers, etc. The client systems 120 each include a client application 125 (e.g., the client applications 125A, 125B, and 125C) that communicates with the distributed database 110, such as by using one or more interfaces of the distributed database system 110. For instance, the distributed database system 110 might provide an application programming interface to facilitate communication with the client systems 120, such as a Representational State Transfer (REST) API. In an exemplary embodiment, the client systems 120 communicate directly with the data servers 116 using the client applications 125 to execute transactions on data stored on the data servers 116. The transactions can be represented using a programming language that one or both of the client applications 125 and an API of the distributed database system 110 are configured to use. In the same or different embodiments, the transactions can include statements represented using other formats, including a declarative programming language, procedural query language, or other type of query language used by the distributed database system 110.

In some embodiments, the client systems 120 communicates with the distributed database system 110 to execute transactions in the distributed database. The transactions may be generated by the client systems 120 via the client applications 125 or other processes executing on the client system 120. Furthermore, the client systems 120 can receive data from the distributed database system 110, such as data requested in a transaction. In an exemplary embodiment, the client systems 120 execute transactions by communicating directly with one or more of the data servers 116. In the same or different embodiments, the client systems 120 communicate with other components of the distributed database system 110 to execute transitions, such as the query servers 112 or the index servers 114. As an exemplary case, transactions executed by the client systems 120 may make modifications to existing records stored by the data servers 116 (i.e., mutations), may add new records for storage in the data servers 116 (i.e., insertions), or may perform deletions. In some embodiments, deletions are effected by marking records as deleted (e.g., soft deletes), with actual removal from storage occurring later based on system criteria. In other embodiments, records may be removed entirely as part of a transaction. Furthermore, although techniques for executing transactions are described herein primarily in relation to mutations and insertions, one skilled in the art will appreciate that other database operations are possible using the same or similar techniques, such as deletions.

In some embodiments, the client application 125 of a client system 120 communicates with the distributed database system 110 via software integrated with a software development kit (SDK) on the client system 120. For instance, the SDK may be an SDK configured for executing transactions at the distributed database system 110. In this case, the client application 125 may execute transactions at the distributed database system 110 using software tools provided by the SDK, such as transaction execution functions, user defined functions, or eventing functions (e.g., Couchbase Eventing Functions). The SDK may be implemented using any suitable programming language (e.g., Java, C++, Python, etc.). The SDK may provide an application programming interface (API) to the client application 125 for executing transactions or otherwise performing operations at the distributed database system 110. Alternatively, or additionally, the client applications 125 may communicate directly with the distributed database system 110 via the same or different API.

The interactions between the client systems 120 and the distributed database system 110 are typically performed via a network 130, for example, via the Internet or via a private network. In one embodiment, the network uses standard communications technologies or protocols. Example networking protocols include the transmission control protocol/Internet protocol (TCP/IP), the user datagram protocol (UDP), internet control message protocol (ICMP), etc. The data exchanged over the network can be represented using technologies and/or formats including JSON, the hypertext markup language (HTML), the extensible markup language (XML), etc. In another embodiment, the entities can use custom or dedicated data communications technologies instead of, or in addition to, the ones described above. The techniques disclosed herein can be used with any type of communication technology, so long as the communication technology supports receiving a web request by the distributed database system 110 from a sender, for example, a client system 120 and transmitting of results obtained by processing the web request to the sender.

### Example Architecture of Database Server for Continuous Backup

FIG. 2 is a block diagram of an embodiment of a database server 200. The database server 200 may be an embodiment of one of the database servers 116 of FIG. 1. The database server 200 includes a transaction module 210, a synchronization module 220, a backup module 230, a failover module 240 and a restore module 250. In other embodiments, the database server 200 may include different or additional components than those shown in FIG. 2. Furthermore, some or all of the operations described for the database server 200 may be performed by other components of the database system 110, or another suitable computing system or device.

The transaction module 210 is configured to manage and execute various database transactions. The database transactions may include (but are not limited to) CRUD (create, read, update, delete) transactions. A create transaction inserts one or more new records into the database. Create transactions may be used when a new user, product, or data entry needs to be added. A read transaction fetches existing data from the database. In some embodiments, an update transaction modifies existing records in the database, allowing data to be changed while keeping the original entry. A delete operation removes a record from the database.

In some embodiments, the database is implemented as an append-only system. In such a system, data is never directly modified or deleted-instead, each new version of a record is appended as a new entry. Prior versions remain in the system until removed through processes such as compaction. Each operation is associated with a monotonically increasing sequence number (seqno), which provides a mechanism to order transactions. However, while seqnos establish the relative ordering of changes, they do not convey the exact time at which a change occurred. For that, a separate timestamp is typically recorded alongside each transaction to capture its actual execution time. This distinction enables both reliable version tracking and accurate point-in-time recovery.

For example, in an append-only system, a create transaction appends a new record with an increasing sequence number (seqno) in the database. An example create transaction record is shown below:

{
“seqno”: 1001,
“user_id”: “123”,
“name”: “John Doe”,
“email”: “john@example.com”,
“status”: “active”,
“timestamp”: “2025-03-15T10:00:00Z”
}

As shown in the above example, a new record corresponding to a new user, John Doe, is created. The data associated with the new user is appended with seqno: 1001. This is a new record, because no previous version exists for this user.

In an append-only system, update transactions do not modify existing records. Instead, a new version is appended with a higher seqno, while the old version remains in history. Examples of update transactions are shown below.

{
“seqno”: 1015,
“user_id”: “123”,
“name”: “John Doe”,
“email”: “john@example.com”,
“status”: “in active”,
“timestamp”: “2025-03-15T10:00:00Z”
}

As shown in the examples above, the updated record for user “123” is appended with a higher seqno value—1015—reflecting a change in the status field from “active” (recorded at seqno: 1001) to “inactive” (recorded at seqno: 1015). Both versions coexist in the append-only system, with the newer version reflecting the current state while the older version remains available for historical reference. Queries that retrieve the latest version will typically select the entry with the highest seqno, while timestamps provide additional context about when each change occurred.

The synchronization module 220 is configured to synchronize data from an active database server 116 to one or more replica database servers 116. In typical distributed database architectures, the active database node is responsible for handling writes and managing live data, while the replica nodes passively receive replicated changes for redundancy and failover purposes. Synchronization is generally unidirectional and does not involve conflict resolution, since replicas do not accept direct writes. Each replica continuously replicates the state from the active node to maintain consistency in the event of a failover.

The backup module 230 is configured to persist data to a backup storage 260. The backup storage 260 may include on-premises infrastructure, such as shared file systems (e.g., NFS), or remote storage provisioned by cloud service providers, including Amazon Web Services (AWS), Google Cloud Platform (GCP), or Microsoft Azure. Backup configuration may vary depending on factors such as compliance needs, durability guarantees, or cost optimization strategies.

In some embodiments, the database system 110 may implement sharding, where the dataset is partitioned across multiple shards, each responsible for a subset of the overall data. A single database server node may manage one or more shards. The backup module 230 is configured to back up data on a per-shard basis, allowing individual shards to be restored independently. This shard-level granularity enhances both scalability and fault tolerance. Accordingly, when the specification refers to a database node storing a “database,” it encompasses the storage of either a full database or a partial (shard-specific) subset thereof.

In some embodiments, the backup module 230 includes a snapshot backup module 232 and a continuous backup module 234. The snapshot backup module 232 is configured to periodically capture database snapshots 262 at scheduled intervals. A snapshot is a point-in-time copy of a database, file system, or storage volume that captures the state of the database at a specific moment. The backup module 230 may initially capture a full backup snapshot, and subsequently capture incremental snapshots which store only changes made after the previous snapshot is taken. In some embodiments, a full snapshot of the database is taken at a first scheduled interval, e.g., daily or weekly, and incremental snapshots may be taken at a second scheduled interval, e.g., hourly or daily.

The continuous backup module 234 is configured to capture and persist transaction logs 264, enabling fine-grained recovery. These transaction logs are generated by the transaction module 210 as part of normal database operations and made available to the continuous backup module for backup. Each transaction log includes a set of transactions, along with associated sequence numbers (seqnos) and timestamps. In some embodiments, the continuous backup module 234 uploads logs at intervals determined by time or log size thresholds—for example, at least every two minutes or when the log exceeds a certain size. For instance, one transaction log may record transactions with seqnos from 0 to 100, and the next may capture seqnos from 101 to 150, depending on activity. This log-based backup complements snapshots by providing high-resolution history, allowing restoration to specific time points.

The failover module 240 is configured to monitor the health of the active database server 200 and detect when a failover event occurs. Upon detection, the failover module promotes a replica database server 116 to active status. The failover module also records a failover log entry, which includes a unique identifier and the sequence number of the last consistent snapshot persisted to disk prior to promotion. The sequence number recorded in the failover log corresponds to the last consistent snapshot persisted to disk prior to promotion. In some embodiments, this may not precisely delineate which transactions were executed by the previous active node versus the newly promoted node, but rather marks a consistent point from which the new node begins execution. In some embodiments, the identifier in the failover log is not the node's identifier but a randomly generated UUID representing the new timeline of execution.

The failover module informs the continuous backup module of the failover event but does not itself initiate any backup operations. In response, the continuous backup module (or its underlying backup system) compares the sequence number of the last backed-up transaction with the last successfully synchronized transaction, as identified via the transaction module. If a gap is detected—for example, if the last backed-up transaction had seqno 165 and the last synchronized transaction had seqno 179—the continuous backup module retrieves the relevant transactions from the transaction log and packages a new backup log that fills the gap. This ensures that no transactions are lost due to failover and that all operations are durably preserved in the backup system.

The restore module 250 is configured to reconstruct the database to a specific point in time based on user-defined time points or timestamps. In some embodiments, the restore module 250 first identifies one or more backup snapshots associated with the specified point in time, which may include a full backup snapshot and one or more incremental backup snapshots. The restore module 250 restores the database system 110 to a baseline version using the identified snapshots. It then identifies backup transaction logs corresponding to the specified point in time and extracts transaction seqnos executed after the most recent identified backup snapshot. The restore module 250 applies or replays transactions associated with the extracted seqnos to the baseline version, causing that the restored database matches the requested moment.

In some embodiments, a single transaction log may contain a first set of transactions performed by a first node (e.g., a previously active database node) and a second set of transactions performed by a second node (e.g., a newly promoted active database node). The restore module 250 may access the failover log to identify the transaction seqno associated with the failover event, replaying the first set of transactions from the first node and the second set of transactions from the second node.

### Example Processes for Continuous Backup in Distributed Database

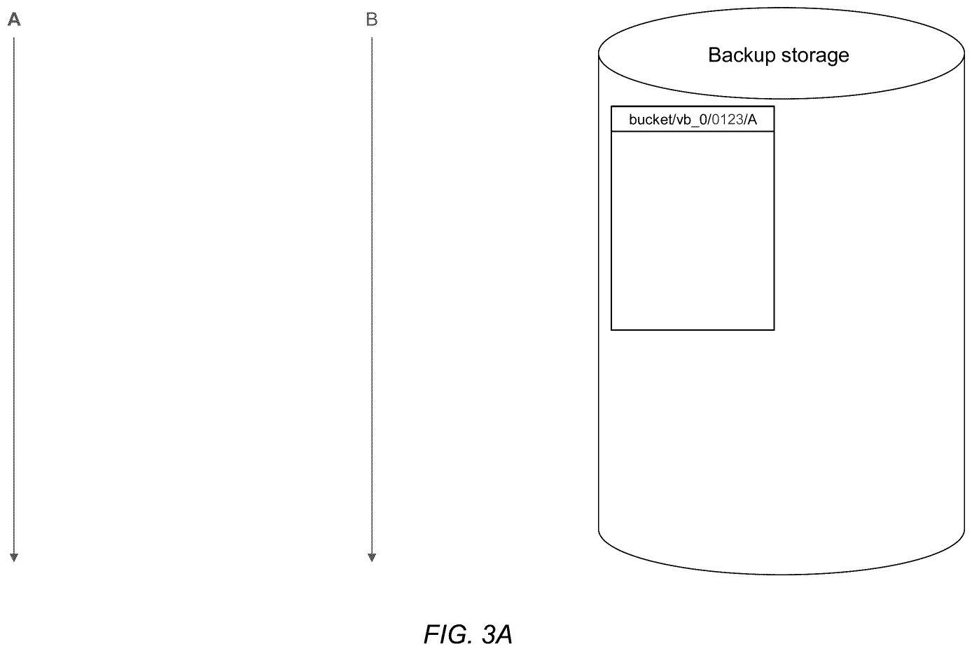

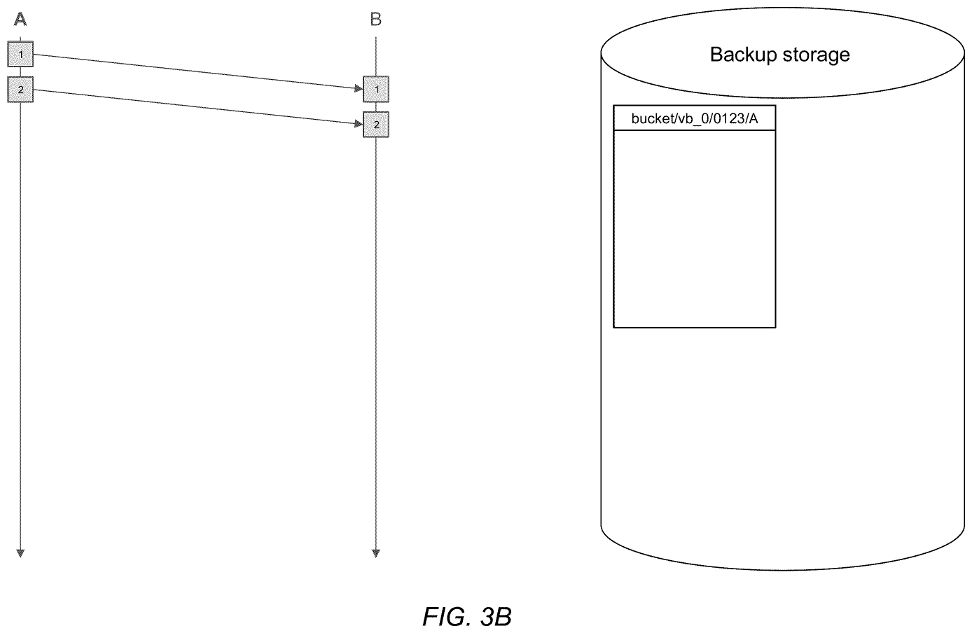

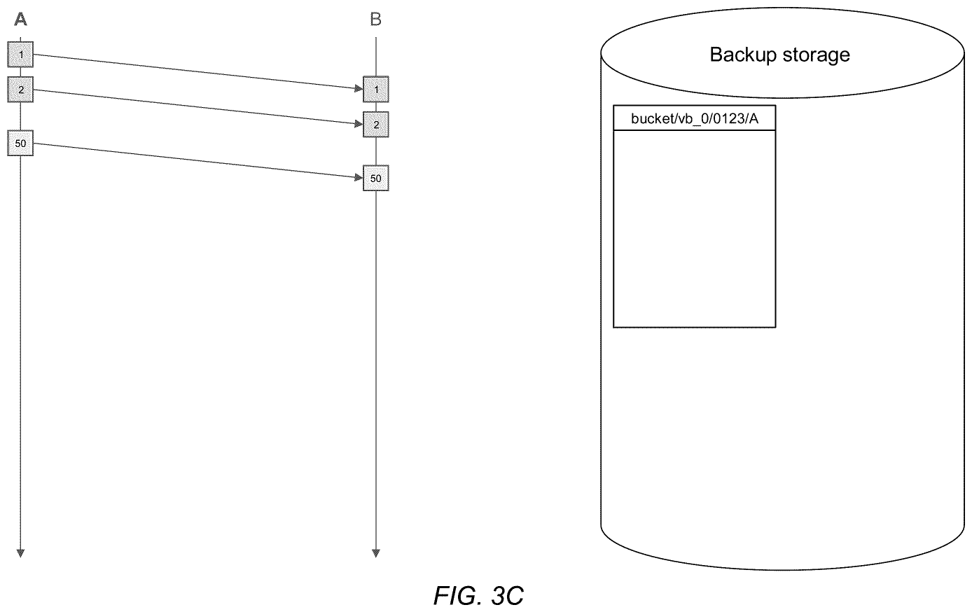

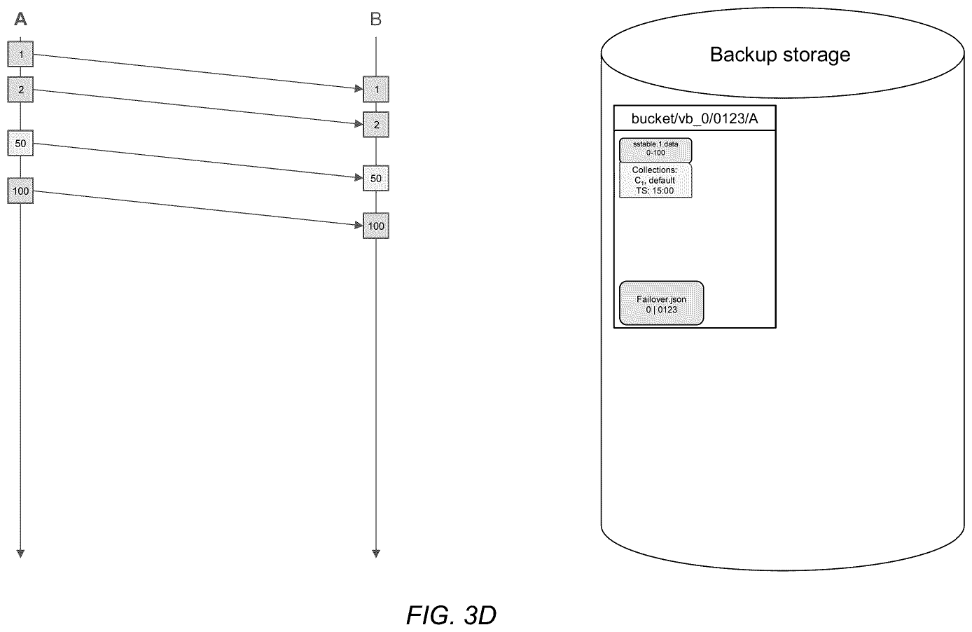

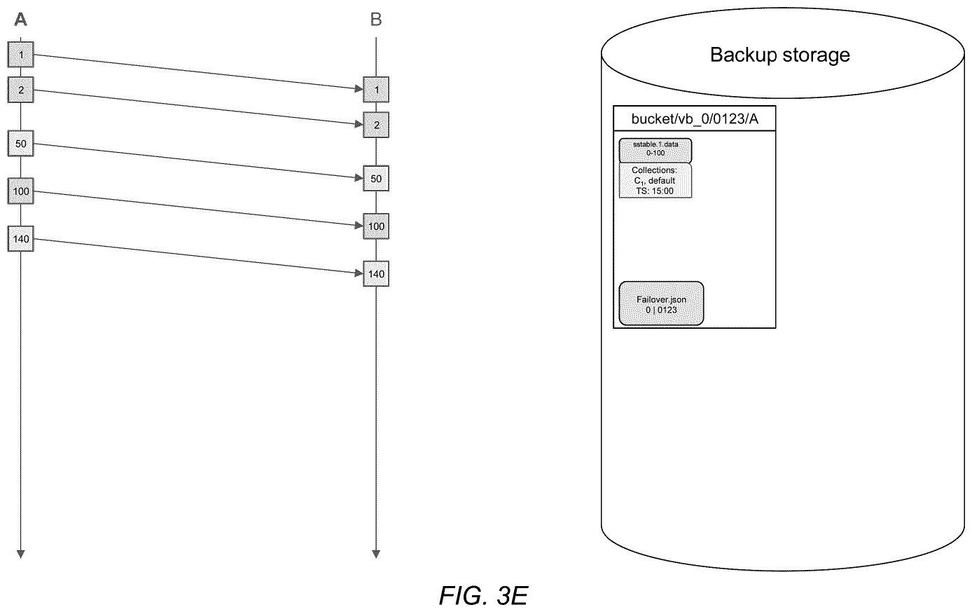

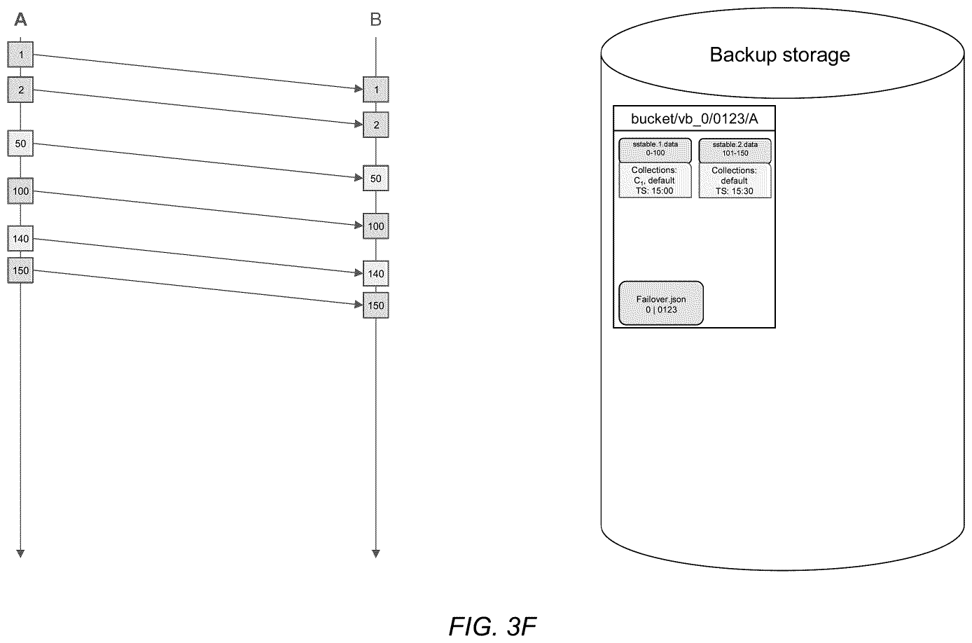

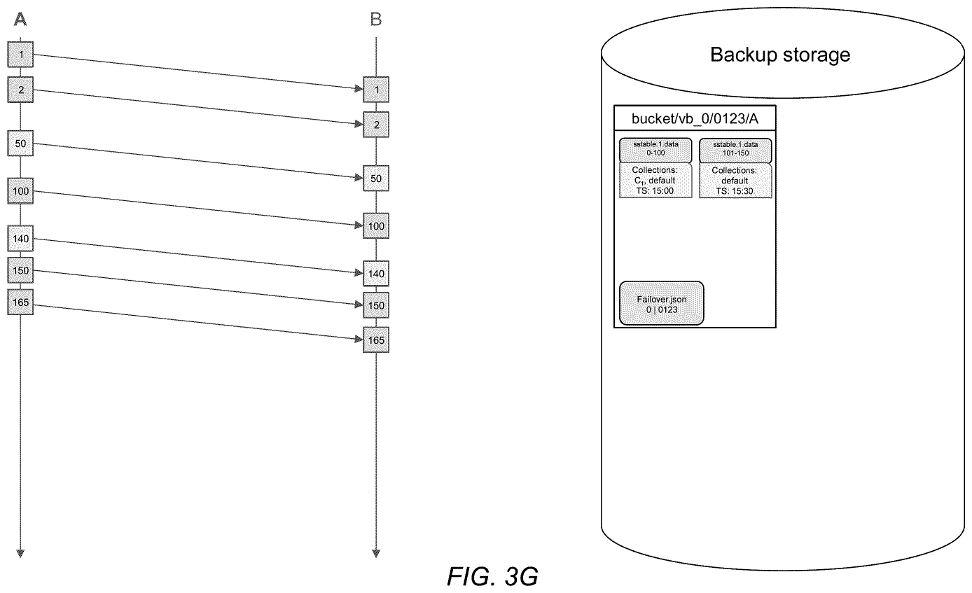

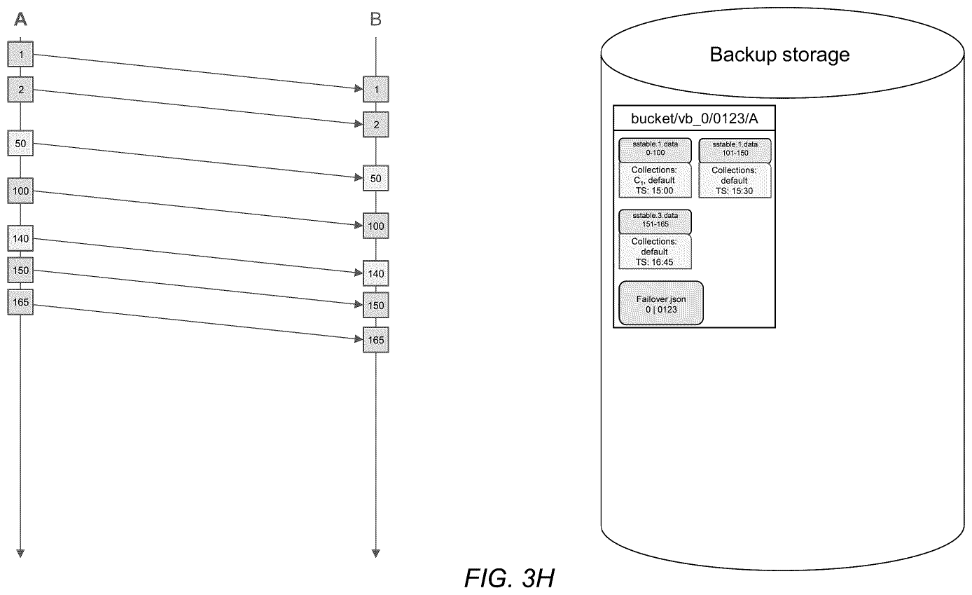

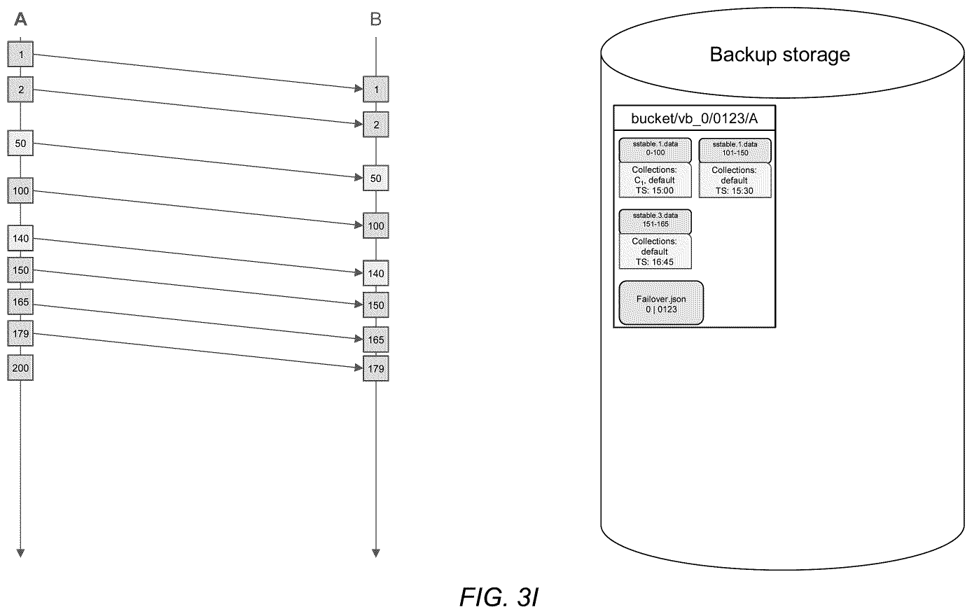

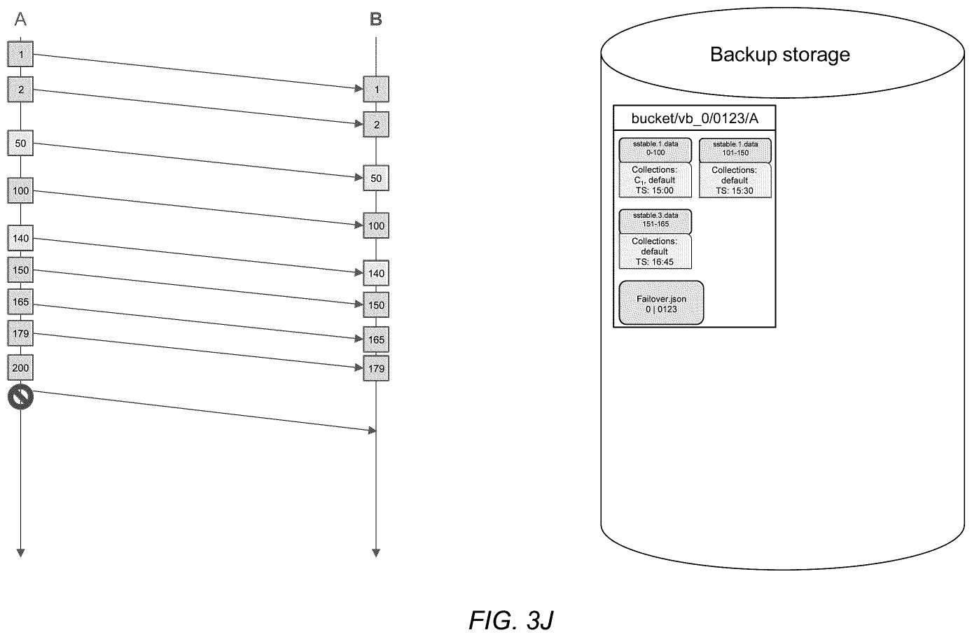

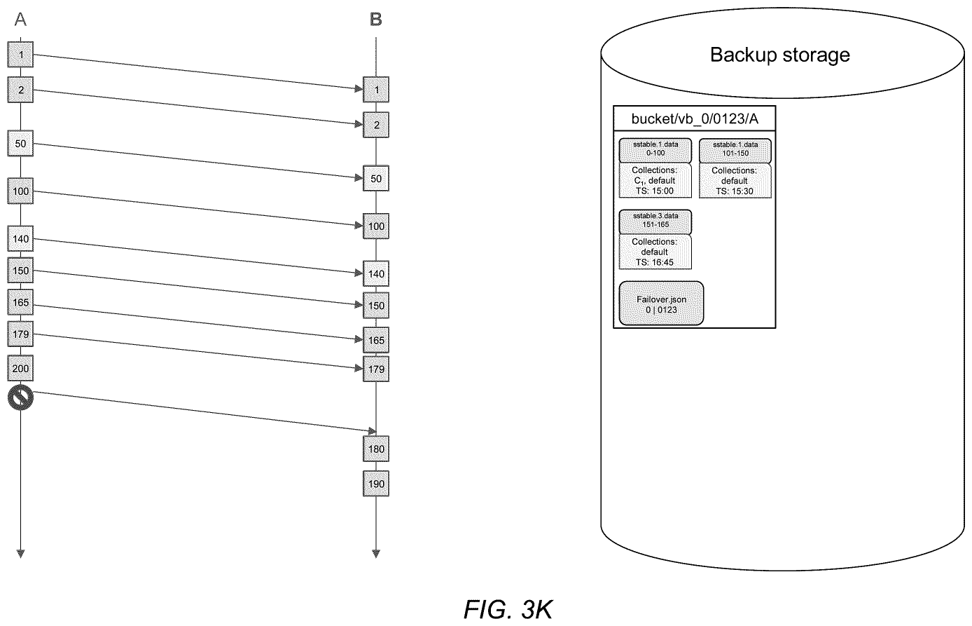

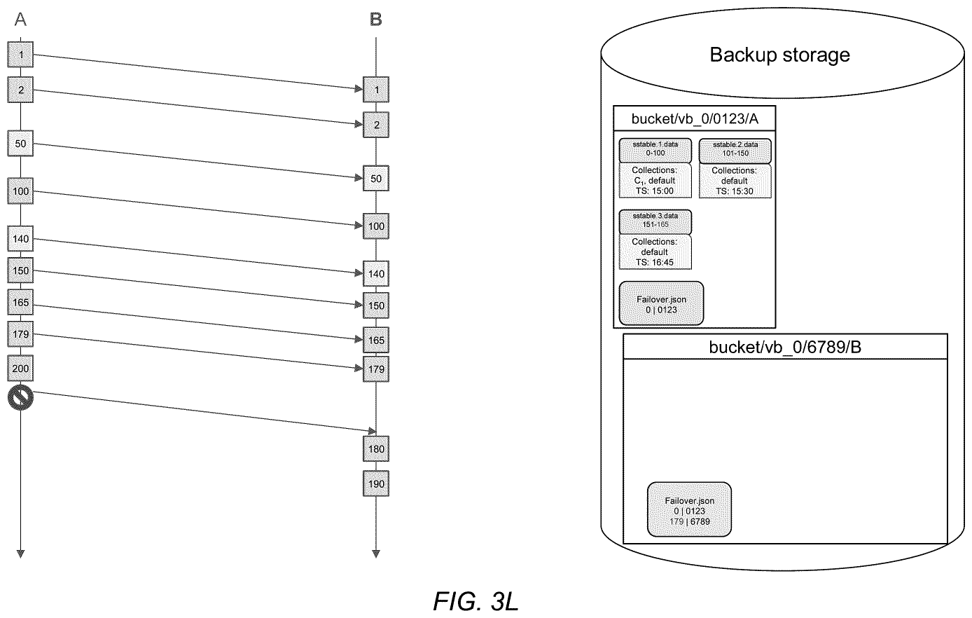

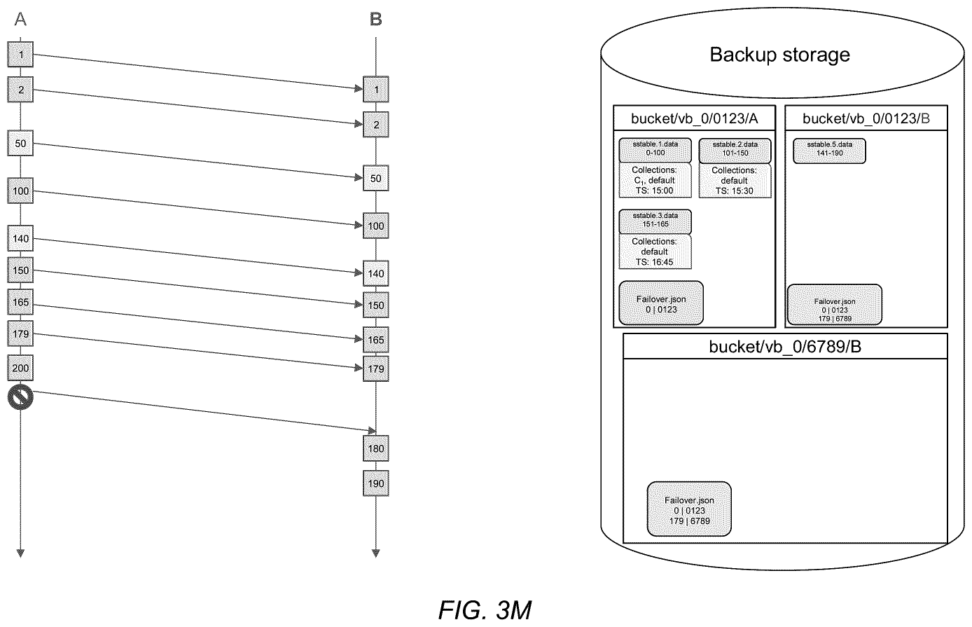

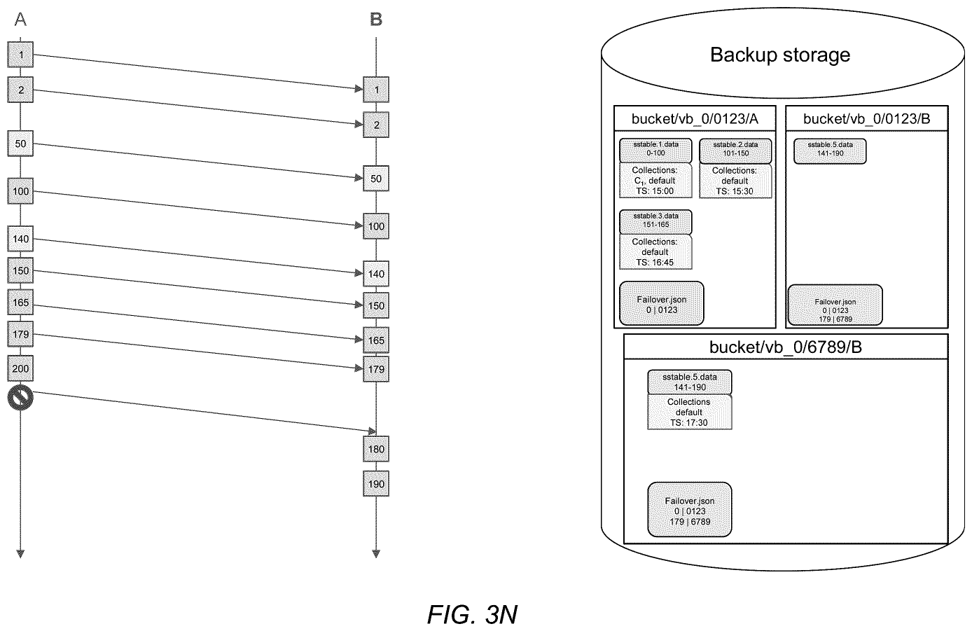

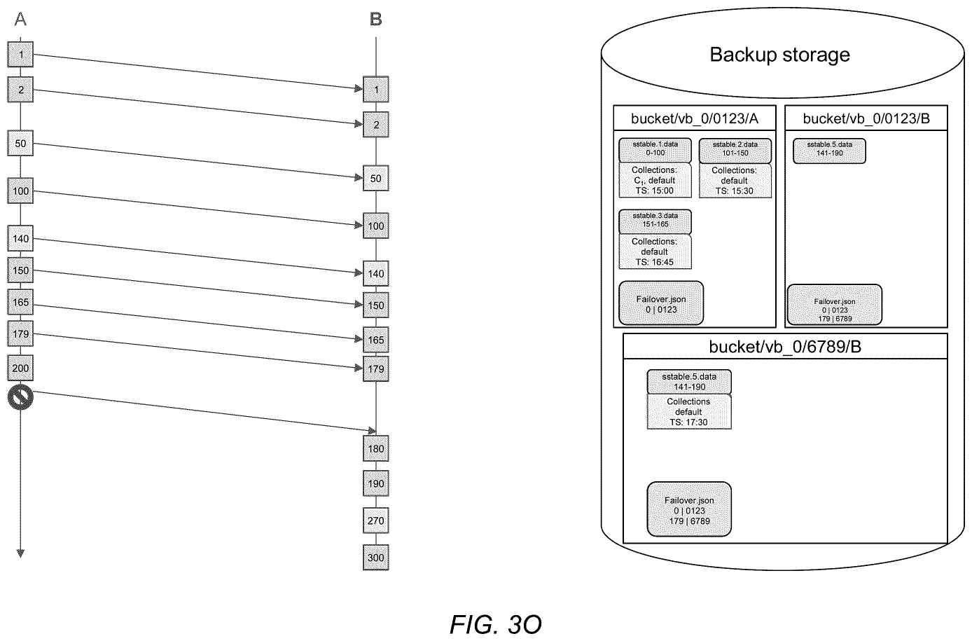

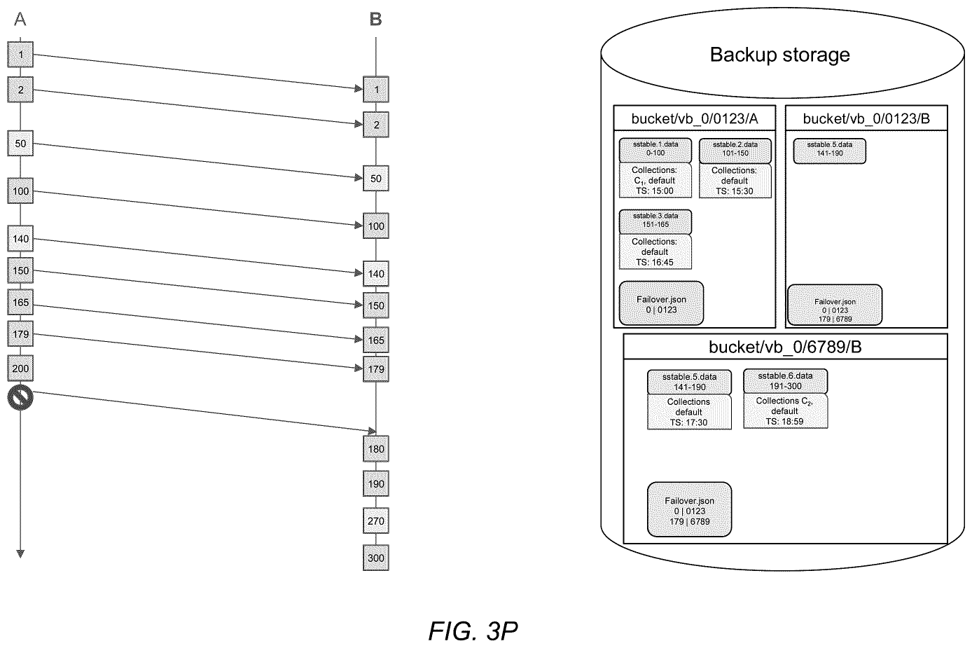

FIGS. 3A-3P are sequence diagrams illustrating embodiments of continuous backup in the distributed database system 110, in accordance with one or more embodiments. FIG. 3A illustrates an initial state of a storage system. A data structure (also referred to as a bucket, bucket/vb_0/0123/A) is created to store backed-up data for node A. The number 0123 represents the UUID of node A. Node A is currently the active database node.

FIG. 3B illustrates that database transactions with seqnos 1-2 are being executed at node A and synchronized with node B (which is a replica database node).

FIG. 3C illustrates that database transactions with seqnos 3-50 are executed at node A and synchronized with node B.

FIG. 3D illustrates that database transactions with seqnos 51-100 are executed at Node A and synchronized with Node B. Additionally, a Sorted String Table (SSTable) file is generated to store a transaction log backing up transactions with seqnos 1-100. Note, in some embodiments, seqno: 0 is reserved and not used for standard transactions. These backed-up transactions include the creation of a new collection, C1, which was created at seqno 50. In some embodiments, a collection is a named container within a scope in a bucket, used to logically group related documents. Collections allow for multi-tenancy, better data isolation, and schema organization within a shared bucket. In some embodiments, collection creation is itself treated as a transaction and assigned a specific sequence number in the log stream. Furthermore, a failover log (e.g., failover.json) is generated to track failover events. As Node A is the initial active database node, the failover log is initialized with a single entry: 0|0123, where 0 indicates the starting sequence number for the timeline and 0123 is a randomly generated UUID identifying that timeline—not the physical node.

Notably, Node A begins backing up transactions only after completing 100 transactions. The backup frequency may be determined based on a balance between data recovery needs, storage efficiency, and system performance. Several factors influence how often backups are performed, including (but not limited to) recovery point objective, write throughput, data change rate, storage constraints, failover and replication mechanisms, and workload. Recovery Point Objective (RPO) defines the maximum acceptable data loss in the event of failure. Systems requiring minimal data loss will have more frequent backups. Databases with high transaction volumes may require frequent incremental backups to efficiently capture changes. In snapshot-based systems, more frequent backups may result in increased metadata storage, though the cost is generally small (e.g., a few kilobytes per backup). Systems with real-time replication may rely more on incremental backups rather than frequent full backups. In some embodiments, snapshot backup operations may be scheduled during off-peak hours to minimize disruption to active database transactions. In some embodiments, the database system 110 may dynamically evaluate these factors to determine an optimal backup frequency. Alternatively, a database administrator may manually configure the backup schedule based on system requirements.

FIG. 3E illustrates that database transactions with seqnos 101-140 are executed at Node A and synchronized with Node B.

FIG. 3F illustrates that database transactions with seqnos 141-150 are executed at Node A and synchronized with Node B. Additionally, another Sorted String Table (SSTable.2.data) file is generated and used to store a transaction log that backs up transactions 101-150. Notably, the collection C1, which was created earlier at seqno 50, is deleted as part of a transaction occurring at seqno 140. Because collection creation and deletion are represented as transactional events, the deletion of C1 is captured in the transaction log. As a result, SSTable.2.data no longer includes metadata or documents associated with collection C1. At this point, there are no additional failover events. As a result, the failover log remains the same.

FIG. 3G illustrates that database transactions with seqnos 151-165 are executed at Node A and synchronized with Node B.

FIG. 3H illustrates that another Sorted String Table (SSTable) file is generated and used to store a transaction log that backs up transactions with seqnos 151-165. At this point, there are still no additional failover events. As a result, the failover log still remains the same.

FIG. 3I illustrates that database transactions with seqnos 166-179 are executed at Node A and synchronized with Node B. Further, database transactions with seqnos 180-200 are also executed at Node A, but these transactions are not synchronized with Node B yet.

FIG. 3J illustrates that before transactions 180-200 can be either replicated to Node B or backed up by Node A, Node A fails. This illustrates that a node's transaction execution may be ahead of both its replication and backup state. Such lag introduces the risk of a gap between the last backed-up transaction and the last successfully synchronized transaction, which needs to be addressed during failover.

FIG. 3K illustrates that in response to Node A's failure, Node B is promoted to active status. At the time of promotion, Node B has only been synchronized through seqno 179. Therefore, its new execution timeline will begin with seqno 180, even though transactions with seqnos 180-200 had previously been executed by Node A. This ensures that Node B begins a clean execution timeline from the last known consistent state.

FIG. 3L illustrates that Node B creates a new backup timeline directory (e.g., bucket/vb_0/6789/B) and generates a new failover.json file containing both the prior timeline (represented as 0|0123) and a new entry, 165|6789. Here, 165 denotes the sequence number where the new timeline begins, and 6789 is a randomly generated UUID uniquely identifying the new execution timeline. These identifiers are not tied to specific physical nodes.

FIG. 3M illustrates that Node B generates a new SSTable.4.data file containing a backup transaction log spanning seqnos 141-190. This log includes a mix of transactions: seqnos 141-165, which were already backed up by Node A; seqnos 166-179, which were executed by Node A but not backed up; and seqnos 180-190, which are newly executed by Node B. The gap between 165 and 179 is filled by re-uploading those transactions from the synchronized replica state on Node B. This broader-range backup ensures that the system has a complete and consistent history.

FIG. 3N illustrates that the SSTable backing up seqnos 141-190 is also stored under Node B's new backup timeline directory. While the data spans two execution timelines, the unified log ensures continuity. The log includes transactions 141-179 executed on the previous timeline (Node A) and transactions 180-190 on the new timeline (Node B). Although a copy of the SSTable was previously stored under the directory for the former timeline (associated with UUID 0123), it is also uploaded under the directory for the new timeline (associated with UUID 6789) to maintain completeness and consistency in the new execution context.

FIG. 3O illustrates that database transactions with seqnos 191-270 are executed at Node B. Notably, the transactions with seqnos 179-270 executed at Node B may be synchronized with another replica database node (not shown).

FIG. 3P illustrates that a new SSTable file is generated to back up transactions with seqnos 191-300. At this point, the system also creates a second collection, C2, which is associated with a specific sequence number (e.g., seqno 100). As with C1, the creation of C2 is itself a transactional event, and the system ensures that no documents assigned to C2 have seqnos lower than the one assigned to its creation. This ordering allows the restore logic to correctly determine whether a collection existed at a given point in time.

The process detailed in FIGS. 3K-3P continues until Node B experiences a failure, whereupon another node—which may or may not be Node A—is elevated to the new active database node. This newly elevated active database node, commonly a former replica database node that had been synchronized with Node B, commences transaction execution from the sequence number (seqno) directly succeeding the latest synchronized seqno and generates a fresh failover log. Should a gap be detected between the previously backed-up transactions and the synchronized transactions, the new active database node identifies this discrepancy and initiates a backup procedure to guarantee data consistency.

### Example Processes for Restoration in Distributed Database

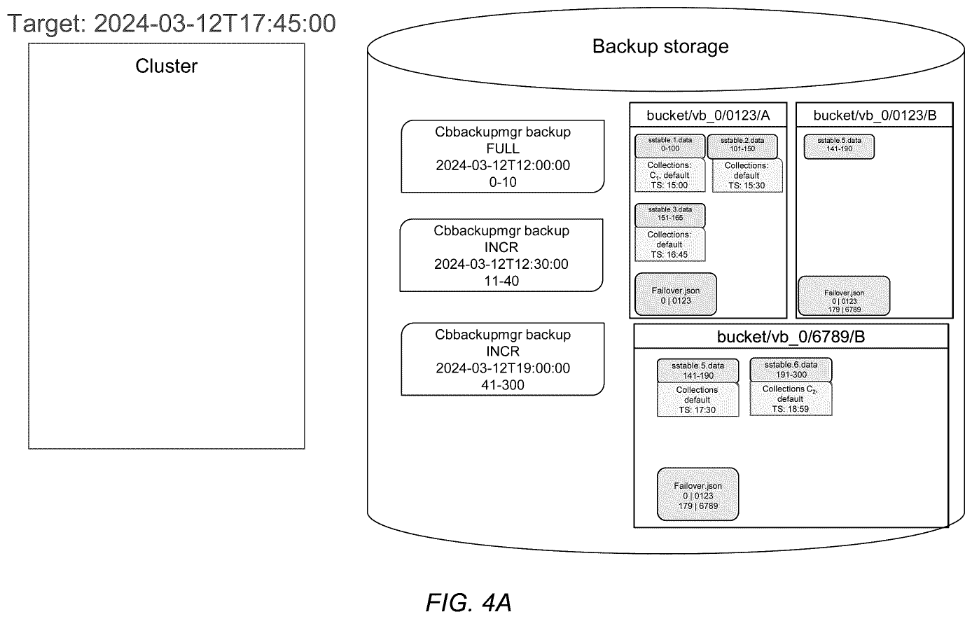

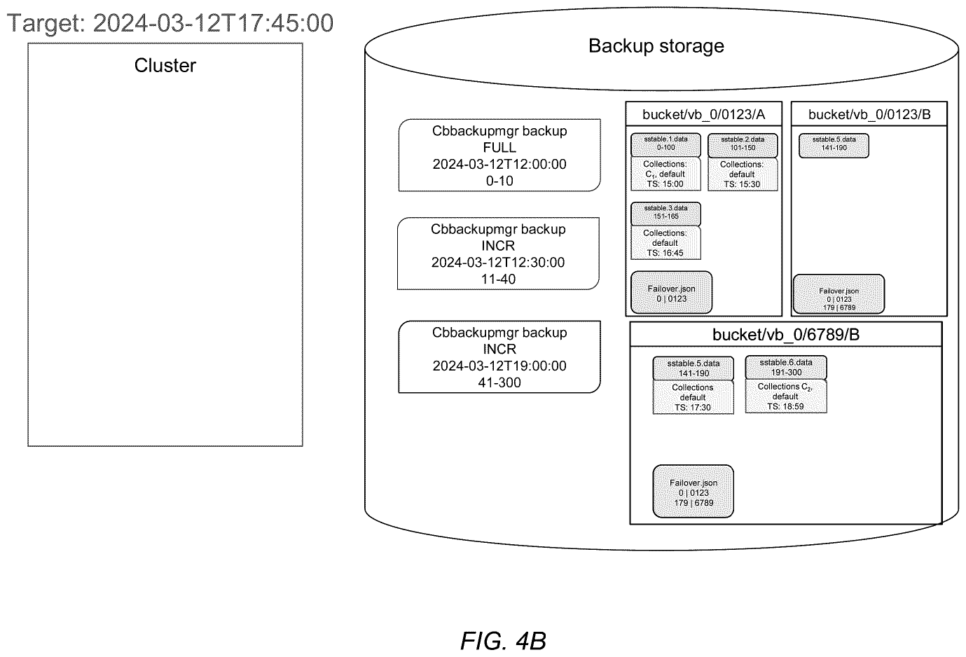

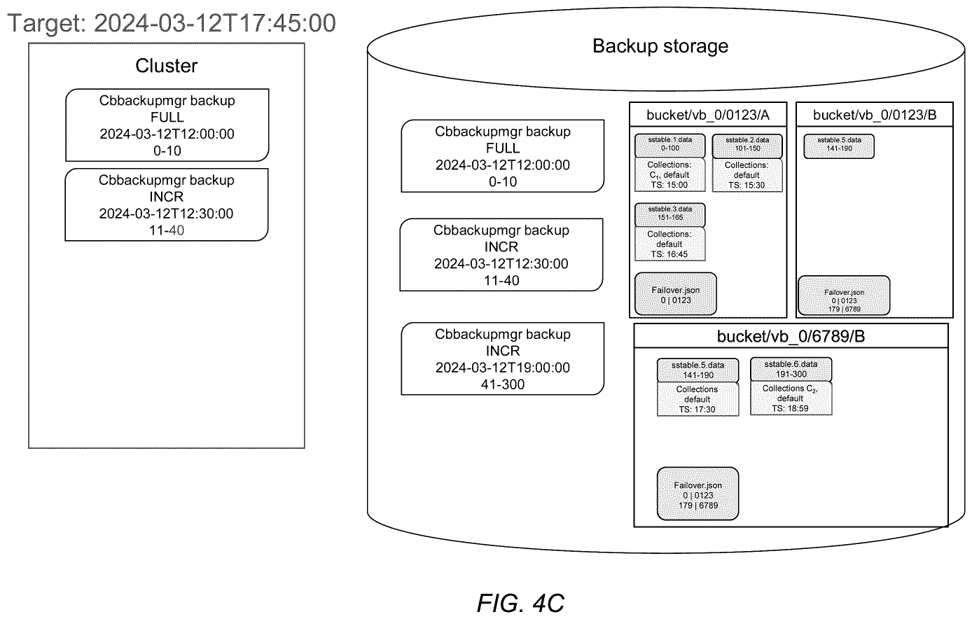

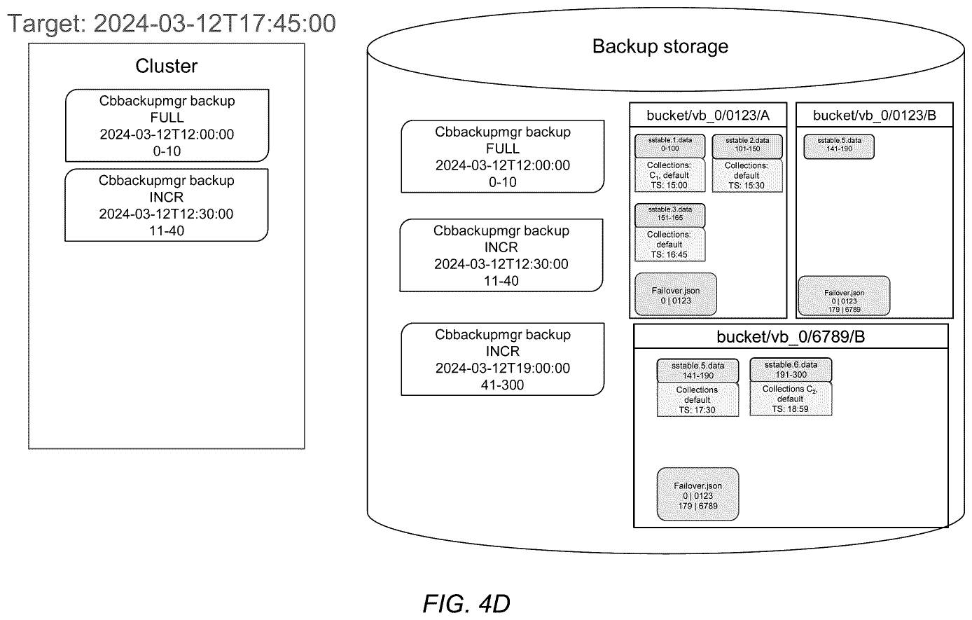

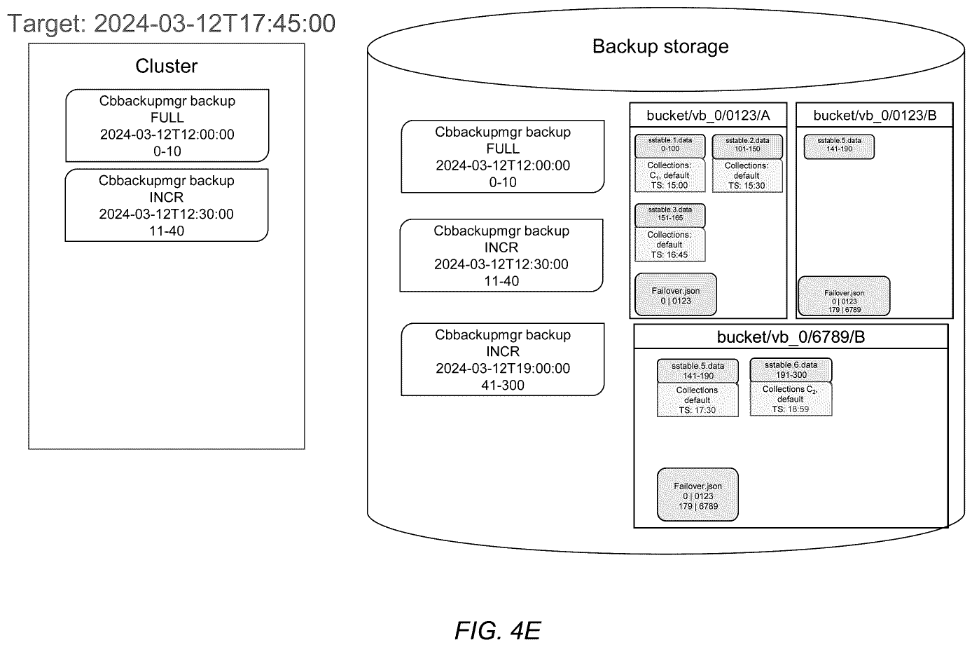

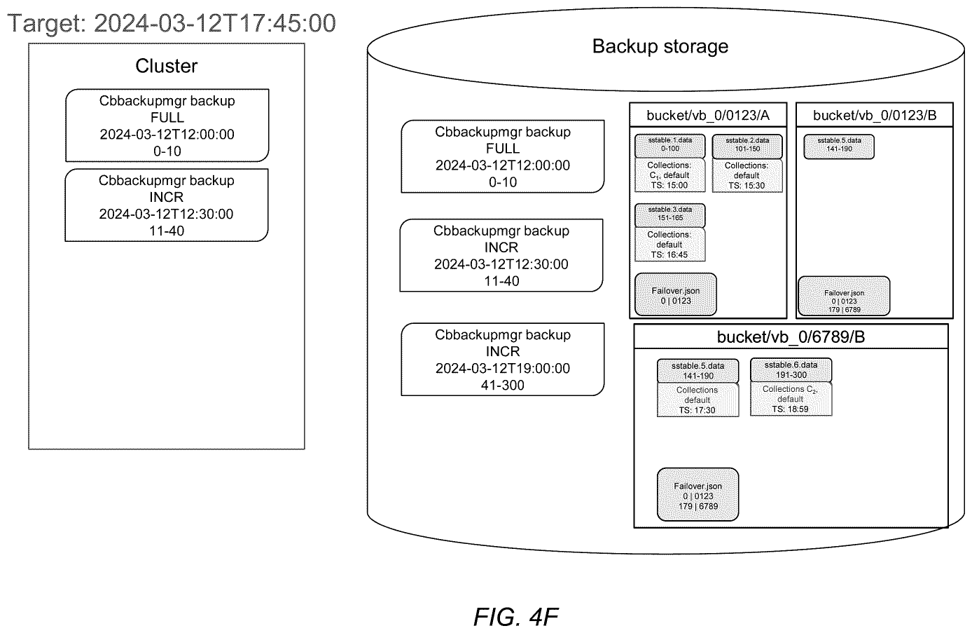

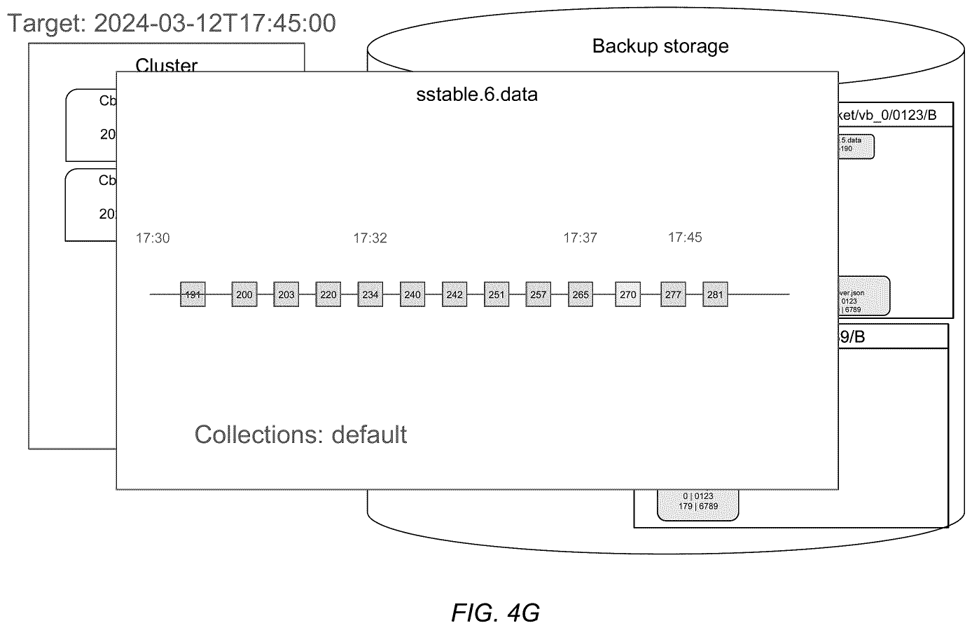

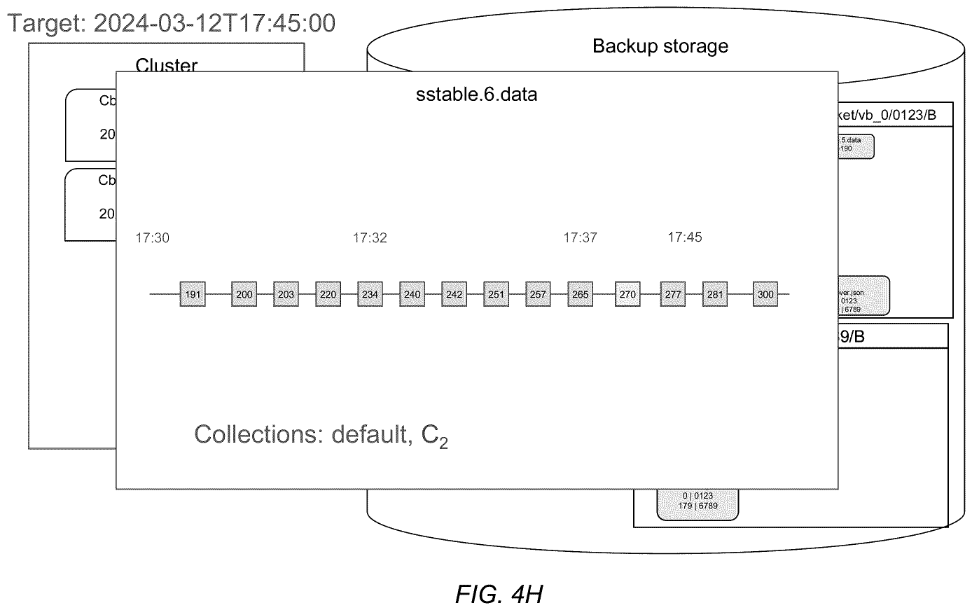

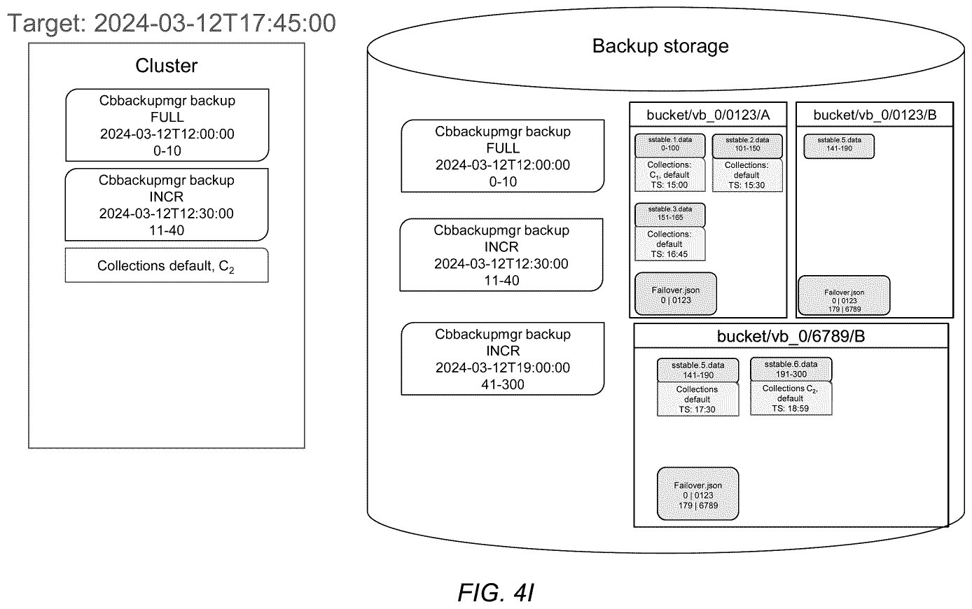

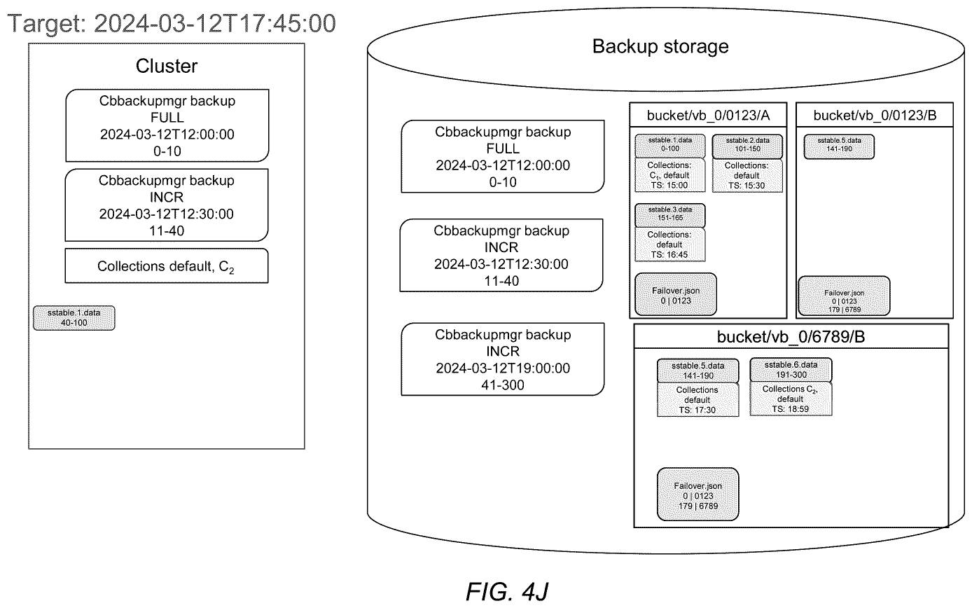

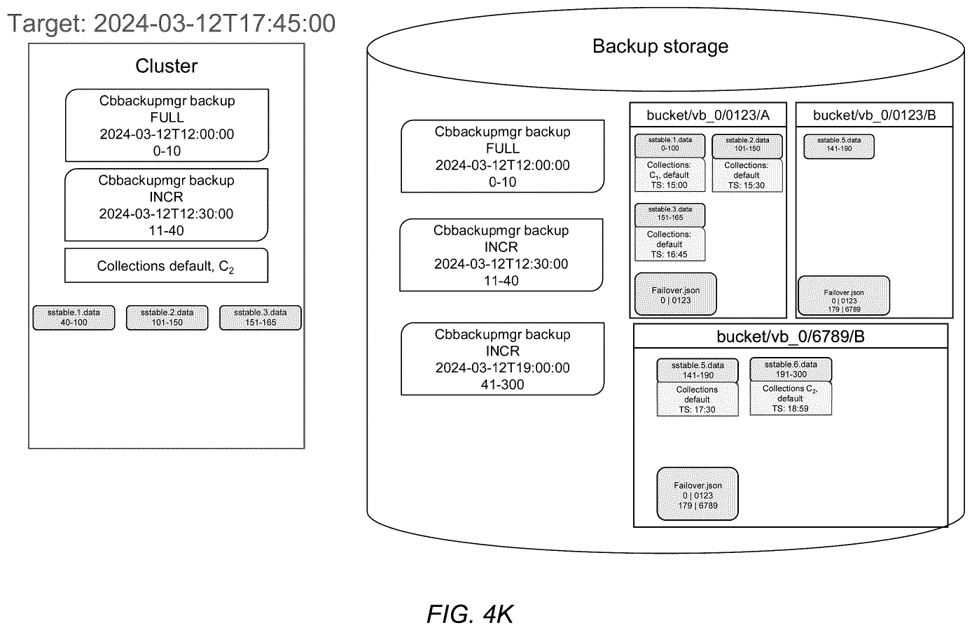

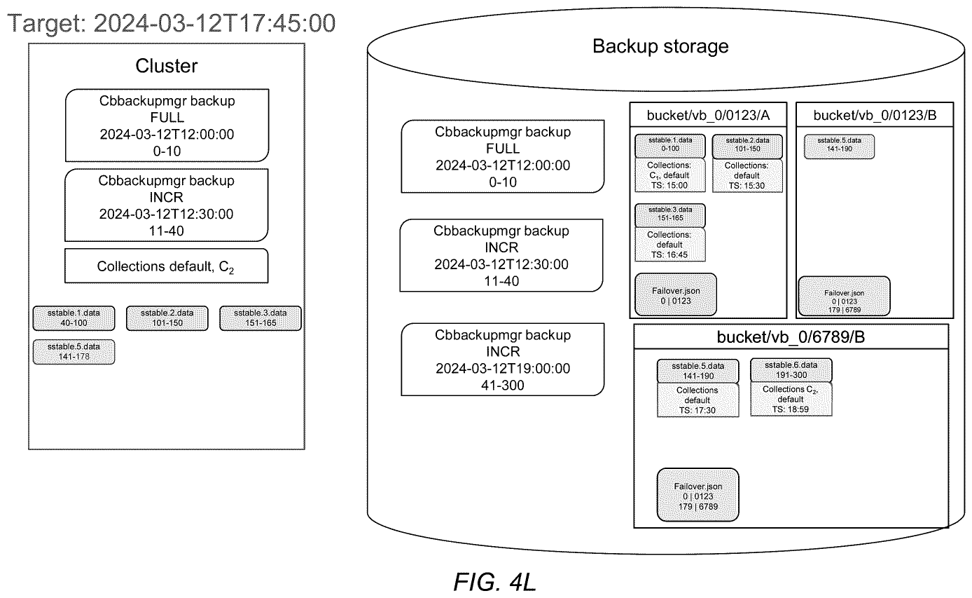

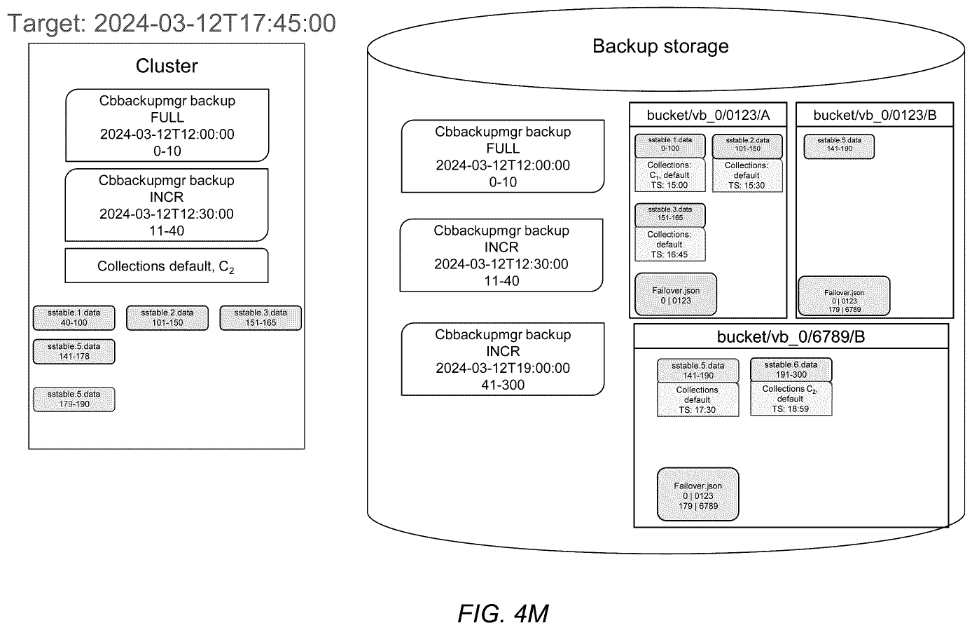

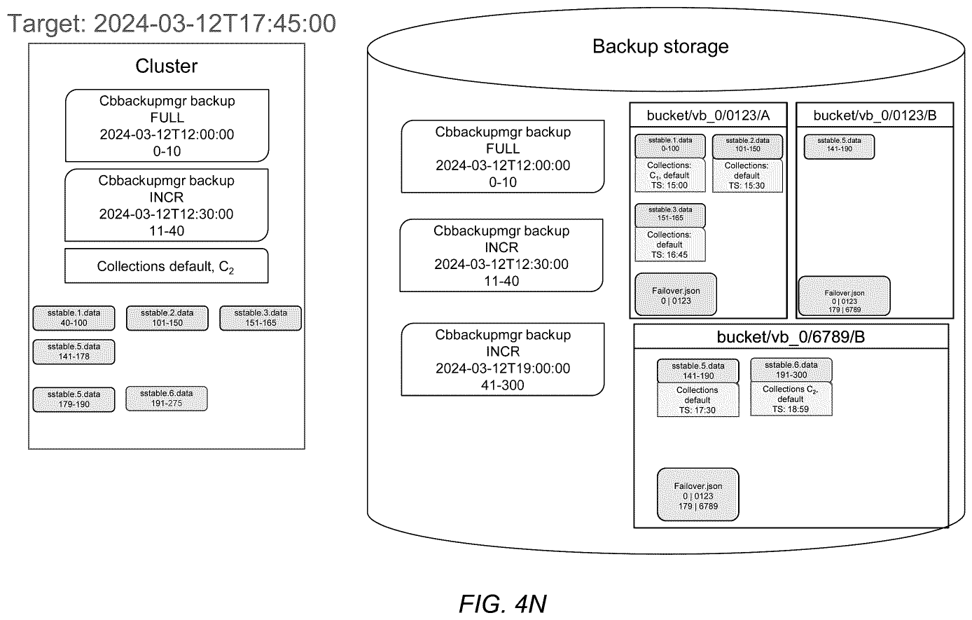

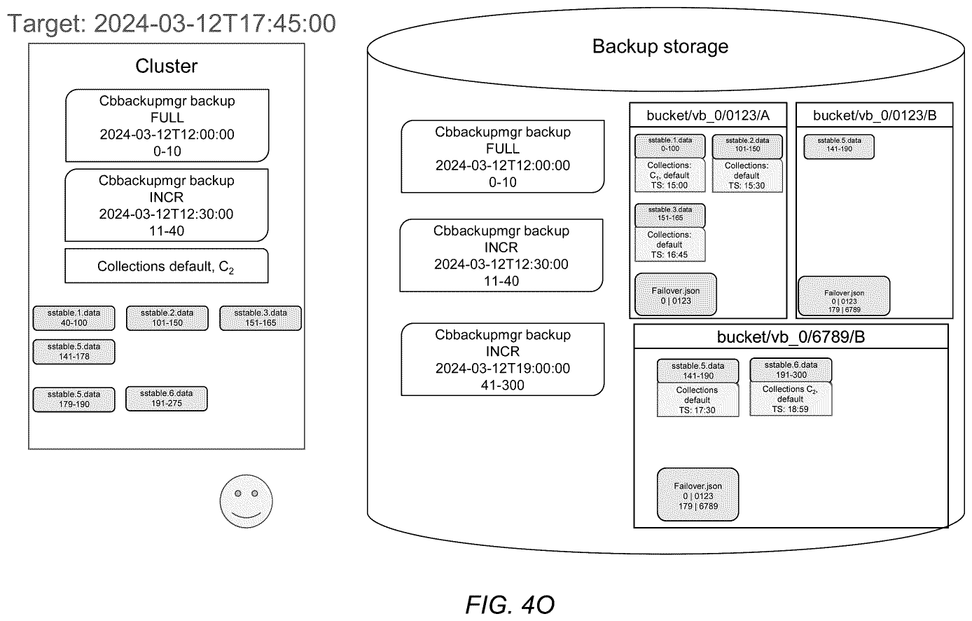

FIG. 4A-4O are sequence diagrams illustrating embodiments of restoration at a specific timestamp in the distributed database system 110, in accordance with one or more embodiments. FIG. 4A illustrates a restoration request with a specific timestamp, e.g., 2024-03-12T17:45:00. This restoration request indicates a request to restore a database system to its state at that precise moment in time corresponding to the specific timestamp.

FIG. 4B illustrates that, in response to receiving the restoration request shown in FIG. 4A, the database system 110 identifies one or more backup snapshots—including a full backup snapshot and an incremental backup snapshot—that contain data from a period before the requested timestamp. For example, the full backup snapshot with a timestamp of 2024-03-12T 12:00:00 includes transactions with seqnos 0-10, and the incremental backup snapshot with a timestamp of 2024-03-12T 12:30:00 includes transactions with seqnos 11-40. Another incremental backup snapshot, with a timestamp of 2024-03-12T19:00:00 and containing transactions with seqnos 41-300, is not included because its timestamp occurs after the requested restoration time.

FIG. 4C illustrates that the identified full backup snapshot and incremental backup shot are added to a cluster for restoration.

FIG. 4D illustrates that the database system 110 also retrieves failover logs to identify failover events that occur before the requested restoration timestamp.

FIG. 4E illustrates that the database system 110 also retrieves the SSTables of the active database node (Node B) that are generated between the timestamp of the latest identified incremental backup snapshot and the requested restoration time. These SSTables include the SSTable.5 with a timestamp 17:30 containing transactions with seqnos 141-190, and the SSTable.6 with a timestamp 18:59 containing transactions with seqnos 191-300.

FIG. 4F illustrates that the database system 110 then retrieves the identified SSTable.5 and SSTable.6 from the bucket associated with Node B. Because the two SSTables end at different timestamps, they may reflect different sets of collections. For example, the collection state at the end of SSTable.6 (timestamp 18.59) is used to determine which collections were present at the requested restoration time. This distinction ensures that only collections valid at the time of restoration are included in the restored view.

FIG. 4G illustrates that the database system 110 identifies a transaction in these identified transaction logs, namely SSTable.5 and SSTable.6 that is immediately before the requested restoration time. Because SSTable.5 ends before the requested time point and does not contain any transactions relevant to the target time, it is not used to determine the applicable collection state. Instead, SSTable.6, which includes transactions spanning past the target restoration time, is used to identify both the most recent transaction before the restore time and the valid collection set at that time. Here, the identified transaction is transaction with seqno 270.

FIG. 4H illustrates that based on the identified transaction with seqno 270, the database system 110 identifies the collection named C2. Because SSTable.6 spans transactions both before and after the restoration point, it includes collection-level metadata such as creation or deletion events. These metadata entries allow the system to reconstruct which collections existed as of the target timestamp.

FIG. 4I illustrates that collection C2 is also added to the cluster for restoration. The valid collections identified from SSTable.6 serve as the basis for selecting documents and transactions to replay during the restore process.

FIG. 4J illustrates that the database system 110 also identifies SSTables from the bucket associated with Node A that includes transactions with sequence numbers higher than the highest sequence numbers in the identified incremental backup snapshot (i.e., 40) and lower than the lowest sequence numbers in the identified collection (i.e., 190). As illustrated, SSTable.1 with transactions 0-100 is identified, and a subset of the transactions with seqnos 40-100 are extracted and included in the cluster.

FIG. 4K illustrates that additional SSTable files—SSTable.2 and SSTable.3—are identified in Node A's backup timeline. These files contain transactions with seqnos 101-150 and 151-165, respectively, and are included in the restoration cluster because they fall between the last transaction in the latest incremental snapshot (seqno 40) and the restoration target (e.g., seqno 270).

FIG. 4L illustrates that the system also identifies SSTable.5 within Node B's backup directory, which backs up transactions with seqnos 141-190. However, based on the failover log indicating a transition to a new execution timeline at seqno 180, only the subset of transactions from seqnos 141-179 (executed by Node A) are used from this file. Transactions with seqnos 180-190, although present in the SSTable file, were not executed by Node A and are therefore not valid on that timeline. These are instead retrieved from Node B's backup timeline to ensure consistency with the restored execution path.

FIG. 4M illustrates that the database system 110 goes to Node B's bucket to retrieve another SSTable.5 with transactions 141-190, and includes these transactions in the cluster for restoration. To perform gap filling based on the failover log, the system selects only the subset of transactions from seqnos 180-190-those executed by Node B after the failover but not yet backed up under the new timeline. These transactions are included in the cluster for restoration to ensure a consistent and complete execution path.

FIG. 4N illustrates that the database system 110 then extracts transactions 191-275 from the SSTable.6.

FIG. 4O illustrates that the database now has all the transactions it needs to restore the database to the requested timestamp.

As described above with respect to FIGS. 4A-4O, the database system 110 is able to restore the database to any given time point by combining backup snapshots and backup transaction logs.

FIGS. 3A-3P and 4A-4O illustrate examples of two-node environments in which the two nodes can fail over to each other. However, this two-node configuration is merely an example. In some embodiments, the database system 110 may include more than two nodes, each capable of failing over to others. At any given time, one or more nodes operate as the active database node(s), while the remaining node(s) function as replicas. In the event of an active database node failure, a replica database node may be promoted to active status. Once the previously failed node recovers, it may resume operation as a replica database node or be promoted back to active status.

Due to failover events, each node may execute only a subset of transactions. To ensure accurate backup and restoration of all transactions across nodes, failover logs are generated to store failover events, their associated sequence numbers (seqnos), and the UUIDs of the newly promoted active database nodes. During the restoration process, the database system 110 uses the failover log to extract transaction subsets from multiple nodes, enabling the reconstruction of a complete and consistent database state.

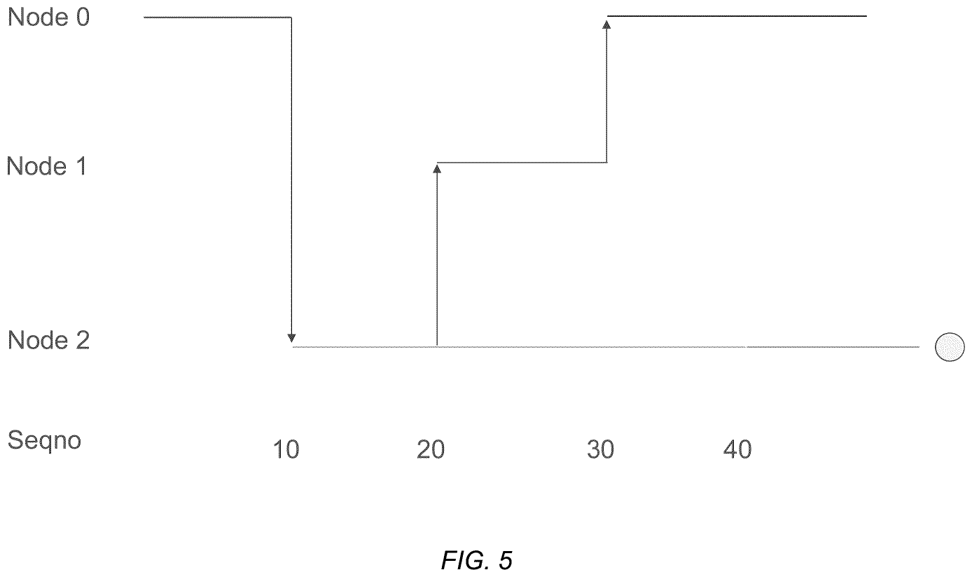

FIG. 5 illustrates an example environment including three nodes: Node 0, Node 1, and Node 2. This environment demonstrates a more complex failover scenario involving a network partition. Initially, Node 0 operates as the active database node, while Nodes 1 and 2 serve as replicas and are synchronized through seqno 10. At seqno 20, a network partition isolates Node 2 from the rest of the cluster. The remaining nodes, having quorum (e.g., Node 1 and Node 0), detect the lack of communication from Node 2 and promote Node 1 to active status. However, because Node 2 is partitioned and cannot detect this failover, it continues to consider itself the active node, leading to a temporary situation where both Node 1 and Node 2 believe they are active. This is reflected in the diagram by arrows showing active-node status diverging.

At seqno 30, Node 0 reboots. In certain implementations, this reboot may trigger a new failover entry in the log. At seqno 40, Node 2 reboots and is shown initiating a new execution timeline (as reflected by a color change in the diagram), further contributing to the timeline branching. Eventually, Node 0 becomes the active node again, taking over from Node 1. This example illustrates that failover events may be driven by fault detection mechanisms, such as quorum loss or recovery, rather than by any fixed schedule based on sequence numbers or time intervals.

### Example Methods for Continuous Backup and Point-In-Time Restoration

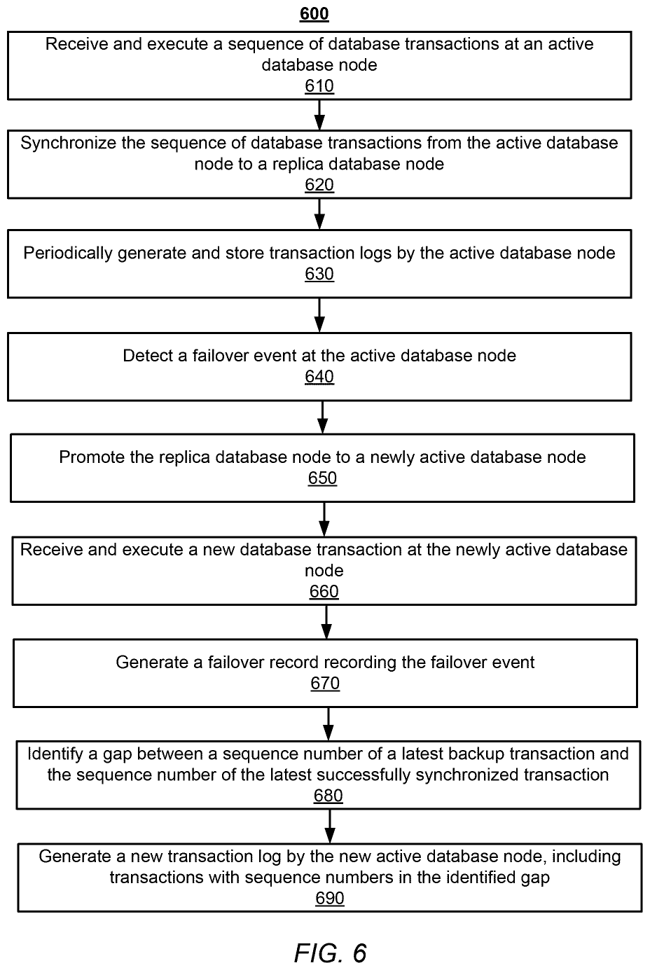

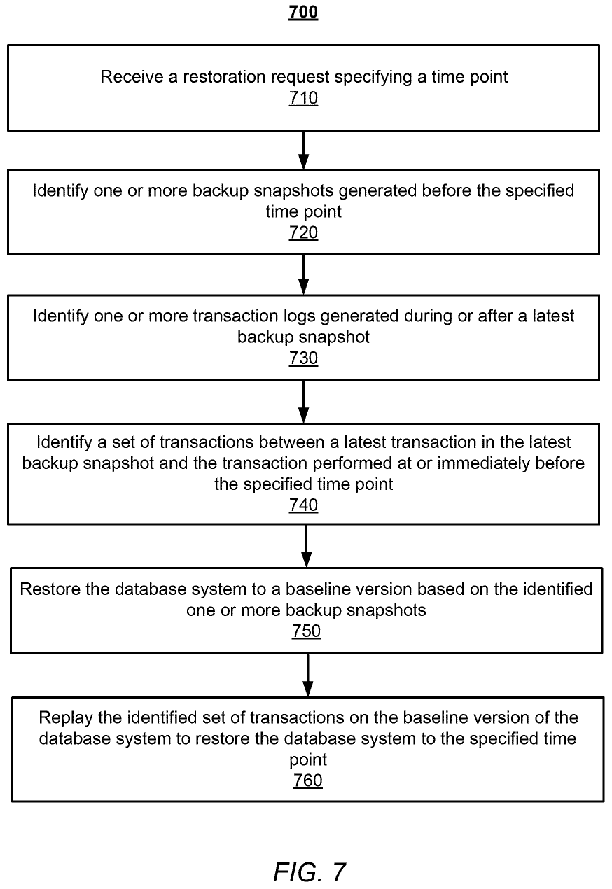

FIGS. 6-7 are flow charts illustrating embodiments of processes related to continuous backup and point-in-time restoration in a distributed database system in accordance with one or more embodiments. As described herein, the processes illustrated in FIGS. 6-7 may be performed by one or more of data servers 116 or 200. For example, the steps of the processes illustrated in FIGS. 6-7 may be performed by one or more components described above with reference to the data server 200. In other embodiments, other entities, such as query servers, index servers, and/or other components in the distributed database system 110, may perform some or all of the steps illustrated in FIGS. 6-7. Embodiments may also include different, fewer, or additional steps or perform the steps in different orders.

FIG. 6 is a flow chart illustrating an example method for continuous backup in a distributed database system (e.g., distributed database system 110) in accordance with one or more embodiments. The distributed database system 110 includes a plurality of database nodes. The plurality of database nodes includes at least an active database node configured to receive and execute transactions, and a replica database node configured to be synchronized with the active database node.

The database system 110 receives and executes 610 a sequence of database transactions at the active database node. Each transaction is assigned a unique, monotonically increasing sequence number (seqno) that reflects its order in the execution timeline. In some embodiments, the database system 110 uses an append-only, log-structured storage architecture—also referred to as the “log is the database” model. In this model, all changes (including updates and deletions) are recorded as new entries appended to immutable log files. In some embodiments, the log files may be in the form of sorted string table (SSTable). Records are not updated in place; rather, the newest version of each record is determined based on the highest seqno. Older versions remain in the system until a compaction process removes obsolete data.

The database system 110 synchronizes 620 the sequence of database transactions from the active database node to one or more replica database nodes. Replication is unidirectional and typically follows a streaming model, in which mutations are continuously pushed from the active node to replicas. Replica nodes apply these changes in order to maintain a consistent state and be ready to take over in the event of a failover. In some embodiments, each node may host multiple shards, and each shard may be replicated independently. As such, replication can occur on a per-shard basis, allowing for fine-grained failover and recovery.

The database system 110 periodically generates and stores 630 transaction logs at the active database node. These logs include a range of consecutive seqnos and associated timestamps. The logs are generated by the transaction module 210 and surfaced to the backup system, which packages and uploads them to backup storage. Log generation may be triggered at a minimum interval (e.g., every two minutes) or sooner if the size of the log exceeds a predefined threshold. This dual trigger-based on time or size-ensures that backups remain timely and efficient, even under bursty or high-throughput workloads.

The database system 110 is also configured to detect 640 a failover event when the active database node becomes unavailable. In response to detecting the failover event, the database system 110 promotes 650 the replica database node to a new active database node, as such the new active database node starts to receive and execute incoming database transactions.

The database system 110 receives and executes 660 a new database transaction at the newly promoted active database node. This transaction is assigned a sequence number that is greater than the latest successfully synchronized transaction from the prior active node. The database system 110 also generates 670 a failover log to record the failover event. Rather than identifying the first transaction performed by the new active node, the failover log records the sequence number of the most recently persisted consistent snapshot at the time of promotion. This sequence number represents the point at which the new execution timeline begins and provides a boundary for determining which transactions belong to the prior node's timeline versus the new one.

For example, referring to FIG. 3L, the last successfully synchronized transaction before failover is the one with seqno 179. Accordingly, the new execution timeline begins at seqno 180, which is recorded in the failover log. The failover log thus includes an entry 180|6789, where 180 is the starting sequence number for the new timeline and 6789 is a randomly generated unique identifier (UUID) representing the new timeline. This entry helps the system determine which transactions were executed before and after the failover event during restoration or backup reconciliation.

The database system 110 also identifies 680 a gap between a sequence number of a latest backed up transaction in the transaction logs and the sequence number of the latest successfully synchronized transaction. For example, referring to FIG. 3L again, the latest backed up transaction in the transaction logs is the transaction with seqno 165, and the latest successfully synchronized transaction is the transaction with seqno 179. Thus, there is a gap between seqno 166 and 179. The database system 110 generates 690 a new transaction log by the new active database node. The new transaction log includes transactions with sequence numbers in the identified gap.

In some embodiments, the new transaction log includes additional transactions before the identified gap and additional transactions after the identified gap. In some embodiments, the new transaction log includes a first set of sequence numbers associated with a first set of transactions executed by the previously active database node, and a second set of sequence numbers associated with a second set of transactions executed by the new active database node. For example, as described above with respect to in FIG. 3O, a new transaction log (SSTable.5) is generated to backup transactions with seqnos 141-190, which covers the seqno gap between 165 and 179. SSTable.5 includes a first set of transactions with seqnos 141-179 executed by the previous active database node (Node A), and a second set of transactions with seqnos 180-190 executed by the new active database node (Node B).

In some embodiments, transaction logs that back up transactions executed by the previously active database node are stored under a directory associated with the prior execution timeline (e.g., using the UUID from the failover log). After a failover, the newly promoted active database node may generate a new transaction log that includes both a first set of transactions executed by the previous node (e.g., seqnos 141-179) and a second set of transactions executed by itself (e.g., seqnos 180-190). This new log—such as SSTable.5—may be stored under the UUID directory corresponding to the previous timeline, but within a subdirectory that reflects the identity of the new active node. This structure enables consistent gap filling and historical reconstruction while maintaining logical separation of execution timelines. As illustrated in FIG. 3O, SSTable.5 is visible from both the previous and new execution contexts and ensures that all transactions, including those spanning the failover, are durably retained.

In some embodiments, the database system 110 also periodically generates and stores backup snapshots by the previously active database node and/or the new active database node. In some embodiments, the backup snapshots are generated at a first frequency (e.g., every hour, every day), and the transaction logs are generated at a second frequency (e.g., every 2 minutes, every 5 minutes) greater than the first frequency. The first frequency and the second frequency may be configured by users or determined based on various factors associated with the database system 110. The database system 110 is able to restore the database to any given time point.

FIG. 7 is a flowchart illustrating an example method for restoring a database system to a specific time point in accordance with one or more embodiments. The database system 110 receives 710 a restoration request specifying a time point. The time point may be specified by a user or an application. The database system 110 identifies 720 one or more backup snapshots generated before the specified time point. The one or more backup snapshots may include a full backup snapshot and one or more incremental backup snapshots. Referring back to FIGS. 4A-4C, based on the restoration time stamp 2024-03-12T 17:45:00, the database system 110 identifies a full backup snapshot with a timestamp 2024 Mar. 12-T 12:00:00 and an incremental backup snapshot with a timestamp 2024-03-12T 12:30:00.

The database system 110 also identifies 730 one or more transaction logs generated during or after a latest backup snapshot among the identified one or more backup snapshots. A latest transaction log among the identified one or more transaction logs includes a transaction performed at or immediately before the specified time point. Referring back to FIGS. 4E-4G, the database system 110 identifies transaction logs, SSTable.5 and SSTable.6 based on their timestamps. From the transactions backed up in SSTable.6, the database system 110 identifies the transaction with seqno 270 is a transaction performed at or immediately before the specified time-point.

In some embodiments, the database system 110 also accesses a failover log to identify a sequence number associated with a failover event. The step of identifying 730 one or more transaction logs generated during or after a latest backup snapshot among the identified one or more backup snapshots includes identifying a first set of transaction logs generated by the previously active database node before the failover event, and identifying a second set of transaction logs generated by the new active database node after the failover event. Referring to FIG. 4D, the database system 110 identifies the failover log including a failover event 180|6789. The database system 110 determines that transactions with seqno below 180 are executed at the previously active database node (Node A), and transactions with seqno 180 or above are executed at the new active database node (Node B). As such, the database system 110 retrieves transaction logs with seqno below 180 from Node A's bucket, and transaction logs with seqno above 180 from Node B's bucket.

The database system 110 also identifies 740 a set of transactions between a latest transaction in the latest backup snapshot and the transaction performed at or immediately before the specified time-point. In some embodiments, the step 740 includes determining that a transaction log among the identified one or more transactions includes a transaction associated with the failover event. Referring back to FIG. 4L, the transaction log SSTable.5 (backing up transactions with seqno 141-190) is identified as including a transaction associated with the failover event (associated with seqno 180).

The database system 110 identifies a first set of transactions recorded in the transaction log with sequence numbers precedent to the sequence number associated with the failover event from the previously active database node's backup data structure, and identifies a second set of transactions with sequence numbers including and subsequent the sequence number associated with the failover event from the new active database node's backup data structure. Referring to FIGS. 4L-4N, a first set of transactions with seqno 141-179 precedent to the seqno 180 associated with the failover event is identified from Node A's bucket, and a second set of transactions with seqno 180-190 including and subsequent to the seqno 180 associated with the failover event is identified from Node B's bucket.

The database system 110 restores 750 the database system 110 to a baseline version based on the identified one or more backup snapshots. The database system 110 then replays 760 the identified set of transactions on the baseline version of the database system 110 to restore the database system 110 to the specified time point. For example, referring to FIG. 4N, the database system 110 can restore the full snapshot and incremental snapshot to generate a base version of the database, which covers transactions up to seqno 40. The database system 110 can then replay transactions with seqno 41 to 275 on the base version to restore the database to the specified time point. As such, the database system 110 uses a combination of backup snapshots and backup transaction logs to enable restoration to any given time point.

### Computer Architecture

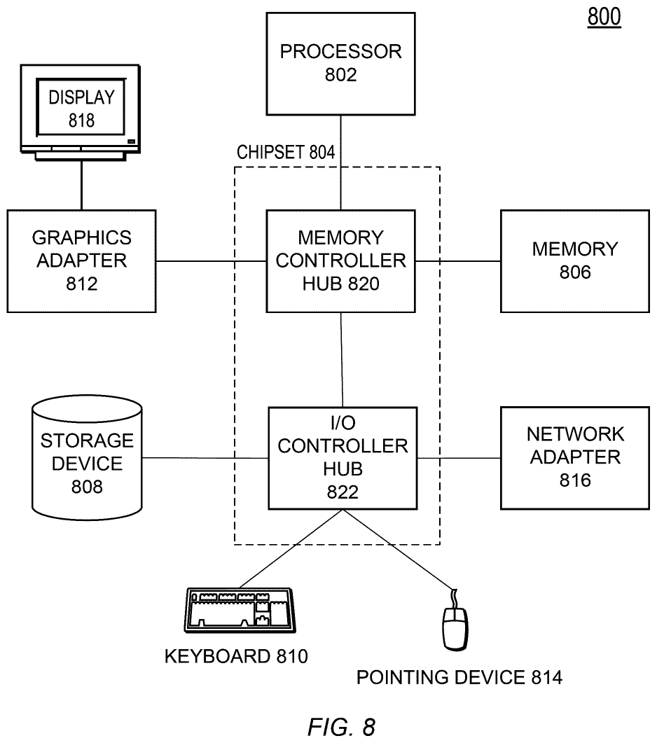

FIG. 8 is a high-level block diagram illustrating a functional view of a typical computer system for use as one of the entities illustrated in the system environment 100 of FIG. 1, according to an embodiment. Illustrated are at least one processor 802 coupled to a chipset 804. Also coupled to the chipset 804 are a memory 806, a storage device 808, a keyboard 810, a graphics adapter 812, a pointing device 814, and a network adapter 816. A display 818 is coupled to the graphics adapter 812. In one embodiment, the functionality of the chipset 804 is provided by a memory controller hub 820 and an I/O controller hub 822. In another embodiment, the memory 806 is coupled directly to the processor 802 instead of the chipset 804.

The storage device 808 is a non-transitory computer-readable storage medium, such as a hard drive, compact disk read-only memory (CD-ROM), DVD, or a solid-state memory device. The memory 806 holds instructions and data used by the processor 802. The pointing device 814 may be a mouse, track ball, or other type of pointing device, and is used in combination with the keyboard 810 to input data into the computer system 800. The graphics adapter 812 displays images and other information on the display 818. The network adapter 816 couples the computer system 800 to a network.

As is known in the art, a computer 800 can have different and/or other components than those shown in FIG. 8. In addition, the computer 800 can lack certain illustrated components. For example, a computer system 800 acting as a server (e.g., a data server 116) may lack a keyboard 810 and a pointing device 814. Moreover, the storage device 808 can be local and/or remote from the computer 800 (such as embodied within a storage area network (SAN)).

The computer 800 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 808, loaded into the memory 806, and executed by the processor 802.

The types of computer systems 800 used by the entities of FIG. 1 can vary depending upon the embodiment and the processing power used by the entity. For example, a client system 120 may be a mobile phone with limited processing power, a small display 818, and may lack a pointing device 814. The entities of the distributed database system 110, in contrast, may comprise multiple blade servers working together to provide the functionality described herein.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

1. A method comprising:
receiving and executing, by a database system comprising a plurality of database nodes, a sequence of database transactions at an active database node, each transaction associated with a monotonically increasing sequence number indicating an order of the transaction in an execution timeline, the database system using an append-only log-structured storage recording transactions as immutable records;
synchronizing the sequence of database transactions from the active database node to a replica database node;
periodically generating and storing transaction logs by the active database node, each transaction log backing up sequence numbers of a set of consecutive executed transactions and respective timestamps, each timestamp being a time point when a corresponding transaction is performed;
in response to detecting a failover event at the active database node, promoting the replica database node to a new active database node;
receiving and executing a new database transaction at the new active database node, the new database transaction associated with a sequence number subsequent to a latest successfully synchronized sequence number;
generating a failover log recording the failover event, the failover log recording a randomly generated unique identifier (UUID) representing a new execution timeline distinct from a physical node identifier, and a sequence number of a last consistent snapshot persisted to disk;
identifying a gap between a sequence number of a latest backed up transaction in the transaction logs generated by a previously active database node and the sequence number of the latest successfully synchronized transaction; and
generating a new transaction log by the new active database node, the new transaction log including transactions with sequence numbers in the identified gap.

2. The method of claim 1, wherein the failover log comprises an identifier of the new active database node and the new database transaction performed by the new active database node.

3. The method of claim 1, wherein transaction logs backing up transactions performed by the previously active database node are stored in a first data structure associated with the previously active database node, and transaction logs backing up transactions performed by the new active database node are stored in a second data structure associated with the new active database node.

4. The method of claim 1, wherein the new transaction log includes a first set of sequence numbers associated with a first set of transactions executed by the previously active database node, and a second set of sequence numbers associated with a second set of transactions executed by the new active database node.

5. The method of claim 4, wherein the new transaction log is stored in both a first data structure associated with the previously active database node and a second data structure associated with the new active database node.

6. The method of claim 1, further comprising:
periodically generating and storing backup snapshots of the database system by the previously active database node or the new active database node.

7. The method of claim 6, wherein the backup snapshots of the database system are generated at a first frequency, and the transaction logs are generated at a second frequency greater than the first frequency.

8. The method of claim 6, further comprising:
receiving a restoration request specifying a time point;
identifying one or more backup snapshots generated before the specified time point;
identifying one or more transaction logs generated during or after a latest backup snapshot among the identified one or more backup snapshots, wherein a latest transaction log among the identified one or more transaction logs includes a transaction performed at or immediately before the specified time point;
identifying a set of transactions between a latest transaction in the latest backup snapshot and the transaction performed at or immediately before the specified time point;
restoring the database system to a baseline version based on the identified one or more backup snapshots; and
replaying the identified set of transactions on the baseline version of the database system to restore the database system to the specified time point.

9. The method of claim 8, further comprising:
accessing the failover log to identify a sequence number associated with the failover event, wherein identifying one or more transaction logs generated during or after a latest backup snapshot among the identified one or more backup snapshots includes:
identifying a first set of transaction logs generated by the previously active database node before the failover event; and
identifying a second set of transaction logs generated by the new active database node after the failover event.

10. The method of claim 8, wherein identifying a set of transactions between the latest transaction in the latest backup snapshot and the transaction performed at or immediately before the specified time point includes:
determining that a transaction log among the identified one or more transaction logs includes a transaction associated with the sequence number associated with the failover event;
identifying a first set of transactions recorded in the transaction log with sequence numbers precedent to the sequence number associated with the failover event from the previously active database node; and
identifying a second set of transactions with sequence numbers including and subsequent the sequence number associated with the failover event from the new active database node.

11. A non-transitory computer readable storage medium for storing instructions that when executed by a client computing device cause the client computing device to perform steps comprising:
receiving and executing, by a database system comprising a plurality of database nodes, a monotonically increasing sequence of database transactions at an active database node of a database system, each transaction associated with a sequence number indicating an order of the transaction in an execution timeline, the database system using an append-only log-structured storage recording transactions as immutable records;
synchronizing the sequence of database transactions from the active database node to a replica database node;
periodically generating and storing transaction logs by the active database node, each transaction log backing up sequence numbers of a set of consecutive executed transactions and respective timestamps, each timestamp being a time point when a corresponding transaction is performed;
in response to detecting a failover event at the active database node, promoting the replica database node to a new active database node;
receiving and executing a new database transaction at the new active database node, the new database transaction associated with a sequence number subsequent to a latest successfully synchronized sequence number;
generating a failover log recording the failover event, the failover log recording a randomly generated unique identifier (UUID) representing a new execution timeline distinct from a physical node identifier, and a sequence number of a last consistent snapshot persisted to disk;
identifying a gap between a sequence number of a latest backed up transaction in the transaction logs generated by a previously active database node and the sequence number of the latest successfully synchronized transaction; and
generating a new transaction log by the new active database node, the new transaction log including transactions with sequence numbers in the identified gap.

12. The non-transitory computer readable storage medium of claim 11, wherein transaction logs backing up transactions performed by the previously active database node are stored in a first data structure associated with the previously active database node, and transaction logs backing up transactions performed by the new active database node are stored in a second data structure associated with the new active database node.

13-14. (canceled)

15. The non-transitory computer readable storage medium of claim 11, further comprising:
periodically generating and storing backup snapshots of the database system by the previously active database node or the new active database node.

16. The non-transitory computer readable storage medium of claim 15, wherein the backup snapshots of the database system are generated at a first frequency, and the transaction logs are generated at a second frequency greater than the first frequency.

17. The non-transitory computer readable storage medium of claim 15, the steps further comprising:
receiving a restoration request specifying a time point;
identifying one or more backup snapshots generated before the specified time point;
identifying one or more transaction logs generated during or after a latest backup snapshot among the identified one or more backup snapshots, wherein a latest transaction log among the identified one or more transaction logs includes a transaction performed at or immediately before the specified time point;
identifying a set of transactions between a latest transaction in the latest backup snapshot and the transaction performed at or immediately before the specified time point;
restoring the database system to a baseline version based on the identified one or more backup snapshots; and
replaying the identified set of transactions on the baseline version of the database system to restore the database system to the specified time point.

18. The non-transitory computer readable storage medium of claim 17, the steps further comprising:
accessing the failover log to identify a sequence number associated with the failover event, wherein identifying one or more transaction logs generated during or after a latest backup snapshot among the identified one or more backup snapshots includes:
identifying a first set of transaction logs generated by the previously active database node before the failover event; and
identifying a second set of transaction logs generated by the new active database node after the failover event.

19. The non-transitory computer readable storage medium of claim 17, wherein identifying a set of transactions between the latest transaction in the latest backup snapshot and the transaction performed at or immediately before the specified time point includes:
determining that a transaction log among the identified one or more transaction logs includes a transaction associated with the sequence number associated with the failover event;
identifying a first set of transactions recorded in the transaction log with sequence numbers precedent to the sequence number associated with the failover event from the previously active database node; and
identifying a second set of transactions with sequence numbers including and subsequent the sequence number associated with the failover event from the new active database node.

20. A computing system, comprising:
one or more processors; and
a non-transitory computer readable storage medium for storing instructions that when executed by a client computing device cause one or more processors to perform steps comprising:
receiving and executing, by a database system comprising a plurality of database nodes, a monotonically increasing sequence of database transactions at an active database node of a database system, each transaction associated with a sequence number indicating an order of the transaction in an execution timeline, the database system using an append-only log-structured storage recording transactions as immutable records;
synchronizing the sequence of database transactions from the active database node to a replica database node of the database system 110;
periodically generating and storing transaction logs by the active database node, each transaction log backing up sequence numbers of a set of consecutive executed transactions and respective timestamps, each timestamp being a time point when a corresponding transaction is performed;
in response to detecting a failover event at the active database node, promoting the replica database node to a new active database node;
receiving and executing a new database transaction at the new active database node, the new database transaction associated with a sequence number subsequent to a latest successfully synchronized sequence number;
generating a failover log recording the failover event, the failover log recording a randomly generated unique identifier (UUID) representing a new execution timeline distinct from a physical node identifier, and a sequence number of a last consistent snapshot persisted to disk;
identifying a gap between a sequence number of a latest backed up transaction in the transaction logs generated by a previously active database node and the sequence number of the latest successfully synchronized transaction; and
generating a new transaction log by the new active database node, the new transaction log including transactions with sequence numbers in the identified gap.

21. The method of claim 1, wherein the new transaction log generated by the new active database node further includes a first set of transactions with sequence numbers before the identified gap that were already backed up by the previously active database node, the transactions with sequence numbers in the identified gap, and a second set of transactions with sequence numbers after the identified gap that are newly executed by the new active database node, such that the new transaction log is a unified log spanning all three ranges to ensure continuity across the failover event.

22. The method of claim 1, wherein the new transaction log is stored in both a first directory associated with a previous execution timeline identified by a first UUID recorded in the failover log and a second directory associated with the new execution timeline identified by the randomly generated UUID.
